(19) United States
(12) Patent Application Publication
(10) Pub. No.: US 2020/0270395 A1
(43) Pub. Date: Aug. 27, 2020

(54) LOW DENSITY VOID CONTAINING FILMS

(71) Applicant: Eastman Chemical Company, Kingsport, TN (US)

(72) Inventors: James Wesley Peer, Kingsport, TN (US); Sunny A. Bhat, Kingsport, TN (US); James Carl Williams, Blountville, TN (US); Rondell Paul Little, Johnson City, TN (US); Kevin Michael Cable, Kingsport, TN (US); Mark Allen Peters, Jonesborough, TN (US)

(73) Assignee: Eastman Chemical Company, Kingsport, TN (US)

(21) Appl. No.: 15/733,047

(22) PCT Filed: Oct. 30, 2018
(86) PCT No.: PCT/US2018/058135

§ 371 Date: Apr. 29, 2020

Related U.S. Application Data
(60) Provisional application No. 62/578,812, filed on Oct. 30, 2017.

(51) Int. Cl. C08G 63/183; C08G 63/199; C08K 7/28; B29C 55/12; B29C 55/04

(52) U.S. Cl. CPC C08G 63/183; C08G 63/199; B29K 2067/003; B29C 55/12; B29C 55/04; C08K 7/28

(57) ABSTRACT

Disclosed are void-containing films and shrinkable films which show excellent density reduction that is retained upon exposures to high temperatures. The voiding agents are hollow glass microspheres. The shrinkable films have high shrinkage and retain their low density after processing under conditions of temperature and moisture used in typical recycling processes. The films are useful as for sleeves, labels, laminates and other shrinkable film applications, and their lower density allows them to be readily separated from soft drink bottles, food containers and the like during recycling operations.

### FIELD OF THE INVENTION

This disclosure pertains to void containing films made from polymer compositions with hollow glass microspheres as the voiding agent. This disclosure also pertains to articles such as sheets, films, shrinkable films, labels, laminates and sleeves prepared from these compositions. The disclosure further pertains to a process for making films that contain hollow glass microspheres.

### BACKGROUND OF THE INVENTION

Films produced from polymers such as polyolefins, polystyrene, poly(vinyl chloride), polyesters and the like, are used frequently for the manufacture of labels for plastic beverage or food containers. Because these containers are often recycled, it is desirable that the label materials are compatible with the recycling process streams and not cause excessive contamination of those streams. For example, in most recycling operations, the bottle or container is the primary object of recycle while the label, because of its printing inks and glues, generally is considered a “contaminant”. As a result, the label is usually isolated and removed. For example, poly(ethylene terephthalate) (“PET”) bottles often use non-shrinking, roll-fed polypropylene (“PP”) labels. Typically, in a recycling operation, the PET bottle polymer is collected and cleaned for reuse, while the polypropylene label is separated and discarded. The separation of these two materials can be easily accomplished by a sink/float process in which, after grinding, the flaked bottle and the label are suspended in water and separated on the basis of their densities. Sink/float processes are particularly efficient for the separation of PET and PP because of the large differences in the densities of these polymers. For example, the density of the water used in most recycle operations is about 1.03 to 1.05 g/cc because of the presence of contaminants, caustic (sodium hydroxide), and solids in the water. PET, with a density of around 1.35 g/cc, will sink to the bottom during the recycling process. Polypropylene, however, has a density of about 0.90 g/cc and will float to the surface of the water where it can be skimmed off. This separation method has made the recycle of PET bottles with PP labels efficient and commercially successful.

In contrast, to the non-shrinking PP labels, most shrink labels made from polymers such as, for example, polyester, polystyrene, and poly(vinyl chloride), have a high densities and cannot be separated from other higher density polymers, such as PET, in a sink/float process. For example, the typical density is about 1.30 g/cc for polyester shrink labels, about 1.05 g/cc for polystyrene labels, and about 1.33 g/cc for PVC labels. If these labels are not removed prior to the sink/float step by some other means such as, for example, by air elutriation or by manually removing them from the bottle, then they will sink with the PET, and they will eventually cause color and haze contamination of the PET. For labels made from PVC, this contamination is particularly undesirable as PVC emits corrosive hydrochloric acid at PET recycle processing temperatures. Polystyrene labels are low enough in density that most of the flakes tend to hang in the sink/float tank, and they can be partially separated by filtering the water. However, the presence of small amounts of polystyrene with recycled PET can cause off-gassing and the release of hazardous styrene monomer during subsequent PET processing. Polyester shrink labels, by contrast, are usually more compatible with reprocessed PET, but still present contamination problems because of the printing inks and glues. A label that can be separated by sink/float processes, therefore, would be highly desirable for packaging applications.

One approach for improving the recycle of polyester shrink labels is to mechanically reduce the density below that of water, for example, by foaming or voiding. Foaming is effective for decreasing the density, but the resulting film is difficult to print and lacks desirable aesthetics. Void-containing films, by contrast, are less difficult to print and often have a desirable opaque matte finish.

Generally, voids are often obtained by incorporating small organic or inorganic particles or by incorporating immiscible polymers into a polymer film and orienting the polymer film by stretching in at least one direction. During stretching, small cavities or voids are formed around the voiding agent. When voids are introduced into polymer films, the resulting void-containing film has a lower density than the non-voided film and becomes opaque. Typical examples of voided films are described in U.S. Pat. Nos. 3,426,754; 3,944,699; 4,138,459; 4,582,752; 4,632,869; 4,770,931; 5,176,954; 5,435,955; 5,843,578; 6,004,664; 6,287,680; 6,500,533; 6,720,085; 7,273,894; U.S. Patent Application Publication No.'s 2001-0036545; 2003-0068453; 2003-0165671; 2003-0170427; 2006-0121219; Japan Patent Application No.'s 61-037827; 63-193822; 2004-181863; European Patent No. 0 581 970 B1, and European Patent Application No. 0 214 859 A2.

Although voided polymer films can be manufactured to have densities below 1 g/cc, these films, however, do not normally retain these lower densities after shrinkage. Density increases of 0.05 to 0.30 g/cc are common under standard shrinkage conditions (e.g. 5 to 10 seconds in a hot air or steam shrink tunnel at 80 to 95° C.). This increase in density results from a reduction in the size of the voids during the shrinkage of the polyester film and can continue in recycling processes, which often employ hot water for grinding or washing the polymer. For example, many recycling processes involve an initial wet or dry grinding step in which the bottles and labels are ground into smaller flakes, followed by a flake-washing step where the combined mix of ground up PET polymer and label are washed for 10 to 15 minutes in a caustic bath at 85° C. (the caustic bath typically consists of 1 to 2 wt % sodium hydroxide in water). In this flake washing process, the film/flake can continue to shrink and tends to absorb water, which further increases the density of the film by filling up some of the voids with water. This shrinkage and absorption of water can increase the density of the polyester film by as much as 0.15 to 0.30 g/cc above the initial densities of the unshrunk film and cause the polyester label material to sink with the PET bottle polymer.

One remedy for the above problem is to increase the number of voids in the initial film, that remain after shrinkage, to impart a lower starting density in order to compensate for the shrinkage-induced increase in density. This remedy may be accomplished by adding more voiding agent to the film. Increasing the level of voiding agent, however, usually makes films that are rough, are easily torn, have poor print quality, and are unacceptably brittle. Furthermore, the increase in density upon shrinkage, generally, is proportional to the amount of voiding agent present. Thus, although the starting film density is reduced significantly with increased voiding agent, the increase in the density after shrinking and during recycling also is greater and there is little overall net benefit. Simply increasing the level of voiding agent, therefore, is not a fully satisfactory approach for most applications.

Conventional voiding agents suffer from several disadvantages. Inorganic agents like calcium carbonate, talc, silica, and the like may be used as voiding agents but, because inorganic substances are typically dense materials, the final density of the shaped article is often too high. In the case of voided films, for example, the reduction in density imparted by voiding is frequently offset by the weight of the inorganic agents.

In view of the above shortcomings, the present disclosure addresses the need for a voided polyester shrink film that will simultaneously maintain a high degree of shrinkage while maintaining a low density after exposed to high temperatures during the recycle process. The shrink films of the present disclosure also maintain adequate smoothness, printability, tear resistance and aesthetics. The shrink films of the present disclosure will have utility in the beverage and food packaging industry for the production of recycle-friendly, void containing shrink labels.

### SUMMARY OF THE INVENTION

The present disclosure is a composition comprising a polymer matrix and a voiding agent that is useful for the preparation of void containing articles. The voiding agents in the present disclosure comprise low density, hollow microspheres. In one embodiment, the low density, hollow microspheres are comprised of glass. In one embodiment, the voiding agents are both immiscible polymers and low density, hollow glass microspheres in combination.

In one embodiment, the films in the present disclosure comprise at least one polymer and hollow microspheres. In another embodiment, the films in the present disclosure comprise at least one polymer and hollow glass microspheres. In another embodiment, the films in the present disclosure are multilayer films comprising (A) at least one layer (layer A) comprising at least one polymer, and (B) at least one layer (layer B) comprising (1) at least one polymer and (2) hollow microspheres, and optionally (C) a tie layer between the layers of the film. Another embodiment of the present disclosure are film laminates comprising (A) at least one layer (layer A) comprising at least one polymer and (B) at least one layer (layer B) comprising (1) at least one polymer and (2) hollow microspheres and optionally (C) a laminating adhesive between the layers of the film laminate.

One embodiment of the present disclosure pertains to a process for producing voided films. In one embodiment, the process produces voided films that exhibit high shrinkage and maintain a low density after shrinkage including, for example, shrinkage that occurs during a plastics recycling process. In another embodiment, the process produces voided films and sheet that have a lower density which allows less material to be used in a specific application.

One embodiment of the present disclosure provides a void containing film comprising a polyester having dispersed therein 1 to 50 wt % of hollow glass microspheres wherein the film has a density less than 1.6 g/cc. One embodiment of the present disclosure provides a void containing film comprising a polyester having dispersed therein 1 to 30 wt % of hollow glass microspheres wherein the film has a density less than 1.6 g/cc. Another embodiment provides a film comprising at least one polymer and hollow glass microspheres, wherein the film has a density of 1.4 g/cc or less. Another embodiment provides a film comprising at least one polymer and hollow glass microspheres, wherein the film has a density of 1.3 g/cc or less. Another embodiment provides a film comprising at least one polymer and hollow glass microspheres, wherein the film has a density of 1.2 g/cc or less. Another embodiment provides a film comprising at least one polymer and hollow glass microspheres, wherein the film has a density of 1.0 g/cc or less. Another embodiment provides a film comprising at least one polymer and hollow glass microspheres, wherein the film has a density of 0.96 g/cc or less. Another embodiment provides a film comprising at least one polymer and hollow glass microspheres, wherein the film has a density of 0.70 g/cc or less. Another embodiment provides a film comprising at least one polymer and hollow glass microspheres, wherein the film has a density of 0.65 g/cc or less.

One embodiment of the present disclosure is low density voided films that float in the sink/float separation processes that are often used at the end of recycling systems, and, consequently, the films can be separated more easily and economically.

One embodiment of the present disclosure is a shrinkable film comprising: (1) at least one polymer and (2) hollow microspheres. One embodiment of the present disclosure is a heat shrinkable film comprising: (1) at least one polymer and (2) hollow glass microspheres. One embodiment of the present disclosure is a multilayer shrinkable film comprising: (A) at least one layer (layer A) comprising at least one polymer, and (B) at least one layer (layer B) comprising (1) at least one polymer and (2) hollow microspheres and optionally a tie-layer. One embodiment of the present disclosure is a multilayer laminate comprising: (A) at least one layer (layer A) comprising at least one polymer, and (B) at least one layer (layer B) comprising (1) at least one polymer and (2) hollow glass microspheres and optionally a laminating adhesive.

One embodiment of the present disclosure is a shrinkable film comprising: (1) at least one polymer and (2) hollow glass microspheres, wherein the film is oriented in at least one direction and has shrinkage in the amount of 20 to 90% in at least one direction and has a density of 1.6 g/cc or less. One embodiment of the present disclosure is a shrinkable film comprising: (1) at least one polymer and (2) hollow glass microspheres, wherein the film is oriented in at least one direction and has shrinkage in the amount of 40 to 85% or from 60 to 80% in at least one direction and has a density of 1.4 g/cc or less.

One embodiment of the present disclosure is a shrinkable film comprising: (1) 50-99 wt % of at least one polymer and (2) 1-50 wt % of hollow glass microspheres, wherein the film is oriented in at least one direction and has shrinkage from 20 to 90% in at least one direction and has a density of 1.4 g/cc or less.

One embodiment of the present disclosure is a shrinkable film comprising: (1) 70-99 wt % of at least one polymer and (2) 1-30 wt % of hollow glass microspheres, wherein the film is oriented in at least one direction and has shrinkage from 20 to 90% in at least one direction and has a density of 1.4 g/cc or less.

One embodiment of the present disclosure is a film or film layer comprising: (1) 50-99 wt % of polymer composition comprising at least one polymer selected from acrylic polymers, polyolefins, cellulose esters, cellulose acetate, cellulose triacetate, cellulose propionate, cellulose butyrate, cellulose acetate propionate, cellulose acetate butyrate, cellulose propionate butyrate, cyclic olefin copolymers, ethylene methyl acrylate copolymer, polycarbonate, polypropylene, polystyrene, polystyrene butadiene copolymers or blends, polyethylene, ethylene/propylene copolymer, ethylene-vinyl acetate (EVA), ethylene vinyl alcohol copolymer, polyvinyl chloride, poly(lactic acid), polyvinylidene chloride, nylon, polyethylene terephthalate (PET), polyesters, copolyesters, and mixtures thereof; and (2) 1-50 wt % of hollow glass microspheres.

One embodiment of the present disclosure is a film or film layer comprising: (1) 70-99 wt % of a polymer composition comprising at least one polymer selected from acrylic polymers, polyolefins, cellulose esters, cellulose acetate, cellulose triacetate, cellulose propionate, cellulose butyrate, cellulose acetate propionate, cellulose acetate butyrate, cellulose propionate butyrate, cyclic olefin copolymers, ethylene methyl acrylate copolymer, polycarbonate, polypropylene, polystyrene, polystyrene butadiene copolymers or blends, polyethylene, ethylene/propylene copolymer, ethylene-vinyl acetate (EVA), ethylene vinyl alcohol copolymer, polyvinyl chloride, poly(lactic acid), polyvinylidene chloride, nylon, polyethylene terephthalate (PET), polyesters, copolyesters, and mixtures thereof; and (2) 1-30 wt % of hollow glass microspheres.

One embodiment of the present disclosure is a film or film layer comprising: (1) 70-99 wt % of a polymer composition comprising a polyester composition comprising: at least one polyester which comprises (a) a dicarboxylic acid component comprising: (i) 70 to 100 mole % of terephthalic acid residues, (ii) 0 to 30 mole % of aromatic and/or aliphatic dicarboxylic acid residues having up to 20 carbon atoms; and (b) a glycol component comprising: (i) 0 to 40 mole % 2,2-dimethylpropane-1,3-diol (neopentyl glycol or NPG) residues; (ii) 0 to 100 mole % 1,4-cyclohexanedimethanol (CHDM) residues; (iii) 0 to 45 mole % 2,2,4,4-tetramethyl-1,3-cyclobutanediol (TMCD) residues; (iv) 0 to 40 mole percent diethylene glycol (DEG) residues, whether or not formed in situ; wherein the remainder of the glycol component comprises: (v) residues of ethylene glycol, and (vi) optionally, 0 to 10 mole % of the residues of at least one other modifying glycol; wherein the total mole % of the dicarboxylic acid component is 100 mole %, and wherein the total mole % of the glycol component is 100 mole %; and (2) 1-30 wt % of hollow glass microspheres.

One embodiment of the present disclosure is a film or film layer comprising: (1) 70-99 wt % of a polymer composition comprising a polyester composition comprising: at least one polyester which comprises (a) a dicarboxylic acid component comprising: (i) 70 to 100 mole % of terephthalic acid residues, and (ii) 0 to 30 mole % of aromatic and/or aliphatic dicarboxylic acid residues having up to 20 carbon atoms; and (b) a glycol component comprising: (i) 10 to 45 mole % 2,2,4,4-tetramethyl-1,3-cyclobutanediol (TMCD)residues; (ii) 60 to 80 mole % 1,4-cyclohexanedimethanol (CHDM) residues; (iii) 0 to 10 mole percent diethylene glycol (DEG) residues, whether or not formed in situ; wherein the remainder of the glycol component comprises: (iv) residues of ethylene glycol, and (v) optionally, 0 to 10 mole % of the residues of at least one other modifying glycol; wherein the total mole % of the dicarboxylic acid component is 100 mole %, and wherein the total mole % of the glycol component is 100 mole %; and (2) 1-30 wt % of hollow glass microspheres.

One embodiment of the present disclosure is a film or film layer comprising: (1) 70-99 wt % of a polymer composition comprising a polyester composition comprising: at least one polyester which comprises (a) a dicarboxylic acid component comprising: (i) 70 to 100 mole % of terephthalic acid residues, (ii) 0 to 30 mole % of aromatic and/or aliphatic dicarboxylic acid residues having up to 20 carbon atoms; and (b) a glycol component comprising: (i) 0 to 35 mole % 1,4-cyclohexanedimethanol (CHDM) residues; (ii) 0 to 40 mole % diethylene glycol (DEG) residues; wherein the remainder of the glycol component comprises: (iii) residues of ethylene glycol, and (iv) optionally, 0 to 15 mole % of the residues of at least one other modifying glycol; wherein the total mole % of the dicarboxylic acid component is 100 mole %, and wherein the total mole % of the glycol component is 100 mole %; and (2) 1-30 wt % of hollow glass microspheres.

One embodiment of the present disclosure is a film or film layer comprising: (1) 70-99 wt % of a polymer composition comprising a polyester composition comprising: at least one polyester which comprises (a) a dicarboxylic acid component comprising: (i) 70 to 100 mole % of terephthalic acid residues (ii) 0 to 30 mole % of aromatic and/or aliphatic dicarboxylic acid residues having up to 20 carbon atoms; and (b) a glycol component comprising: (i) 0 to 40 mole % 1,4-cyclohexanedimethanol (CHDM) residues; (ii) 5 to 40 mole % 2,2-dimethylpropane-1,3-diol (neopentyl glycol or NPG) residues; (iii) 0 to 20 mole % diethylene glycol (DEG) residues, whether or not formed in situ; wherein the remainder of the glycol component comprises: (iv) residues of ethylene glycol, and (v) optionally, 0 to 15 mole % of the residues of at least one other modifying glycol; wherein the total mole % of the dicarboxylic acid component is 100 mole %, and wherein the total mole % of the glycol component is 100 mole %; and (2) 1-30 wt % of hollow glass microspheres.

One embodiment of the present disclosure is a film or film layer comprising: (1) 70-99 wt % of a polymer composition comprising a polyester composition comprising: at least one polyester which comprises (a) a dicarboxylic acid component comprising: (i) 70 to 100 mole % of terephthalic acid residues, and (ii) 0 to 30 mole % of aromatic and/or aliphatic dicarboxylic acid residues having up to 20 carbon atoms; and (b) a glycol component comprising: (i) 10 to 45 mole % 2,2,4,4-tetramethyl-1,3-cyclobutanediol (TMCD)residues; (ii) 60 to 80 mole % 1,4-cyclohexanedimethanol (CHDM) residues; (iii) 0 to 10 mole percent diethylene glycol (DEG) residues, whether or not formed in situ; wherein the remainder of the glycol component comprises: (iv) residues of ethylene glycol, and (v) optionally, 0 to 10 mole % of the residues of at least one other modifying glycol; wherein the total mole % of the dicarboxylic acid component is 100 mole %, and wherein the total mole % of the glycol component is 100 mole %; and (2) 1-30 wt % of hollow glass microspheres.

One embodiment of the present disclosure is a film or film layer comprising: (1) 70-99 wt % of a polymer composition comprising a polyester composition comprising: at least one polyester which comprises (a) a dicarboxylic acid component comprising: (i) 70 to 100 mole % of terephthalic acid residues (ii) 0 to 30 mole % of aromatic and/or aliphatic dicarboxylic acid residues having up to 20 carbon atoms; and (b) a glycol component comprising: (i) 5 to 40 mole % 2,2-dimethylpropane-1,3-diol (neopentyl glycol or NPG) residues; (ii) 0 to 10 mole % 1,4-cyclohexanedimethanol (CHDM) residues; (iii) 0 to 10 mole percent diethylene glycol (DEG) residues, whether or not formed in situ; wherein the remainder of the glycol component comprises: (iv) residues of ethylene glycol, and (v) optionally, 0 to 10 mole % of the residues of at least one other modifying glycol; wherein the total mole % of the dicarboxylic acid component is 100 mole %, and wherein the total mole % of the glycol component is 100 mole %; and (2) 1-30 wt % of hollow glass microspheres.

One embodiment of the present disclosure is a film or film layer comprising: (1) 70-99 wt % of a polymer composition comprising a polyester composition comprising: at least one polyester which comprises (a) a dicarboxylic acid component comprising: (i) 70 to 100 mole % of terephthalic acid residues, (ii) 0 to 30 mole % of aromatic and/or aliphatic dicarboxylic acid residues having up to 20 carbon atoms; and (b) a glycol component comprising: (i) 10 to 45 mole % 2,2,4,4-tetramethyl-1,3-cyclobutanediol (TMCD)residues; or (i) 15 to 40 mole % 2,2,4,4-tetramethyl-1,3-cyclobutanediol residues (TMCD); (ii) 0 to 80 mole % 1,4-cyclohexanedimethanol (CHDM) residues; or (ii) 60 to 80 mole % 1,4-cyclohexanedimethanol (CHDM); (iii) 0 to 10 mole percent diethylene glycol (DEG) residues, whether or not formed in situ; wherein the remainder of the glycol component comprises: (iv) residues of ethylene glycol, and (v) optionally, 0 to 10 mole % of the residues of at least one other modifying glycol; wherein the total mole % of the dicarboxylic acid component is 100 mole %, and wherein the total mole % of the glycol component is 100 mole %; and (2) 1-30 wt % of hollow glass microspheres.

One embodiment of the present disclosure is a film or film layer comprising: (1) 70-99 wt % of a polymer composition comprising a polyester composition comprising: at least one polyester which comprises (a) a dicarboxylic acid component comprising: (i) 70 to 100 mole % of terephthalic acid residues (ii) 0 to 30 mole % of aromatic and/or aliphatic dicarboxylic acid residues having up to 20 carbon atoms; and (b) a glycol component comprising: (i) 15 to 28 mole % 1,4-cyclohexanedimethanol (CHDM) residues; (ii) 2 to 20 mole % diethylene glycol (DEG) residues, whether or not formed in situ; (iii) 0 to 30 mole % of the residues of at least one other modifying glycol; and wherein the remainder of the glycol component comprises: (iv) residues of ethylene glycol, and wherein the total mole % of the dicarboxylic acid component is 100 mole %, and wherein the total mole % of the glycol component is 100 mole %;

and (2) 1-30 wt % of hollow glass microspheres.

One embodiment of the present disclosure is a film or film layer comprising: (1) 70-99 wt % of at least one polymer comprises a polyester composition comprising: (A) 10-99 wt % of at least one polyester which comprises (a) a dicarboxylic acid component comprising: (i) 70 to 100 mole % of terephthalic acid residues, (ii) 0 to 30 mole % of aromatic and/or aliphatic dicarboxylic acid residues having up to 20 carbon atoms; and (b) a glycol component comprising: (i) 22 to 83 mole % ethylene glycol residues (EG); (ii) 15 to 28 mole % 1,4-cyclohexanedimethanol (CHDM) residues; (iii) 2 to 20 mole % diethylene glycol (DEG) residues, whether or not formed in situ; (iv) 0 to 30 mole % of the residues of at least one other modifying glycols; and wherein the total mole % of the dicarboxylic acid component is 100 mole %, and wherein the total mole % of the glycol component is 100 mole %; and (B) 1-20 wt % of at least one polymer selected from acrylic polymers, polyolefins, cyclic olefin copolymers, ethylene methyl acrylate copolymer, polypropylene, polystyrene, polystyrene butadiene copolymer or blend, polyethylene, ethylene/propylene copolymer, ethylene vinyl acetate copolymer (EVA), ethylene vinyl alcohol copolymer, polyvinyl chloride, poly(lactic acid), polyesters, copolyester, and mixtures thereof; (C) 0-30 wt % at least one polymer selected from cellulose acetate, cellulose triacetate, cellulose propionate, cellulose butyrate, cellulose acetate propionate, cellulose acetate butyrate, cellulose propionate butyrate, and mixtures thereof; and (D) 0-5 wt % ethylene methyl acrylate copolymer; (E) 0-5 wt % TiO₂; and (2) 1-30 wt % of hollow glass microspheres.

One embodiment of the present disclosure is a film or film layer comprising: at least one polymer which comprises a polyester composition comprising (1) 30-96 wt % of at least one polyester which comprises (a) a dicarboxylic acid component comprising: (i) 70 to 100 mole % of terephthalic acid residues, (ii) 0 to 30 mole % of aromatic and/or aliphatic dicarboxylic acid residues having up to 20 carbon atoms; and (b) a glycol component comprising: (i) 22 to 83 mole % ethylene glycol residues; (ii) 15 to 28 mole % 1,4-cyclohexanedimethanol (CHDM) residues; (iii) 2 to 20 mole % diethylene glycol (DEG) residues, whether or not formed in situ; (iv) 0 to 30 mole % of the residues of at least one other modifying glycol; and wherein the total mole % of the dicarboxylic acid component is 100 mole %, and wherein the total mole % of the glycol component is 100 mole %; and (2) 1-20 wt % of at least one polymer selected from acrylic polymers, polyolefins, cyclic olefin copolymers, ethylene methyl acrylate copolymer, polypropylene, polystyrene, polystyrene butadiene copolymer or blend, polyethylene, ethylene/propylene copolymer, ethylene-vinyl acetate (EVA), ethylene/vinyl alcohol copolymer, polyvinyl chloride, poly(lactic acid), polyesters, copolyesters, and mixtures thereof; (3) 1-15 wt % at least one polymer selected from cellulose acetate, cellulose triacetate, cellulose propionate, cellulose butyrate, cellulose acetate propionate, cellulose acetate butyrate, cellulose propionate butyrate, and mixtures thereof; and (4) 1-5 wt % ethylene methyl acrylate copolymer; and (5) 1-30 wt % of hollow glass microspheres

One embodiment of the present disclosure is a film or film layer comprising: at least one polymer which comprises a polyester composition comprising: (1) 45-98 wt % of at least one polyester which comprises (a) a dicarboxylic acid component comprising: (i) 70 to 100 mole % of terephthalic acid residues (ii) 0 to 30 mole % of aromatic and/or aliphatic dicarboxylic acid residues having up to 20 carbon atoms; and (b) a glycol component comprising: (i) 22 to 83 mole % ethylene glycol residues; (ii) 15 to 28 mole % 1,4-cyclohexanedimethanol (CHDM) residues; (iii) 2 to 20 mole percent diethylene glycol (DEG) residues, whether or not formed in situ; (iv) 0 to 30 mole % of the residues of at least one other modifying glycol; and wherein the total mole % of the dicarboxylic acid component is 100 mole %, and wherein the total mole % of the glycol component is 100 mole %; (2) 1-20 wt % of at least one polymer selected from acrylic polymers, polyolefins, polypropylene, polystyrene, polyethylene, ethylene/propylene copolymer, ethylene-vinyl acetate (EVA), ethylene/vinyl alcohol copolymer, polyvinyl chloride, poly(lactic acid), polyesters, copolyesters, and mixtures thereof; and (3) 0-5 wt % ethylene methyl acrylate copolymer; and (4) 1-30 wt % of hollow glass microspheres.

One embodiment of the present disclosure is a film or film layer comprising: at least one polymer which comprises a polyester composition comprising: (1) 40-98 wt % of at least one polyester which comprises (a) a dicarboxylic acid component comprising: (i) 70 to 100 mole % of terephthalic acid residues (ii) 0 to 30 mole % of aromatic and/or aliphatic dicarboxylic acid residues having up to 20 carbon atoms; and (b) a glycol component comprising: (i) 22 to 83 mole % ethylene glycol residues; (ii) 15 to 28 mole % 1,4-cyclohexanedimethanol (CHDM) residues; (iii) 2 to 20 mole percent diethylene glycol (DEG) residues, whether or not formed in situ; (iv) 0 to 30 mole % of the residues of at least one other modifying glycol; and wherein the total mole % of the dicarboxylic acid component is 100 mole %, and wherein the total mole % of the glycol component is 100 mole %; (2) 1-20 wt % of at least one polymer selected from acrylic polymers, polyolefins, polypropylene, polystyrene, polyethylene, ethylene/propylene copolymer, ethylene vinyl acetate copolymer (EVA), ethylene vinyl alcohol copolymer, polyvinyl chloride, poly(lactic acid), polyesters, copolyesters, and mixtures thereof; and (3) 0-5 wt % ethylene methyl acrylate copolymer; and (4) 0-5 wt % TiO₂. %; and (5) 1-30 wt % of hollow glass microspheres

One embodiment of the present disclosure is a film or film layer comprising: (1) 70-99 wt % of at least one polymer composition comprising: (a) 10-70 wt % of at least one of cellulose acetate, cellulose triacetate, cellulose propionate, cellulose butyrate, cellulose acetate propionate, cellulose acetate butyrate, cellulose propionate butyrate, and mixtures thereof; (b) 1-30 wt % of a plasticizer; (c) 0-10 wt % ethylene methyl acrylate copolymer; and (d) 0-20 wt % of an impact modifier; and (2) 1-30 wt % of hollow glass microspheres.

One embodiment of the present disclosure is a film or film layer comprising: (1) 70-99 wt % of at least one polymer composition comprising: (a) 10-70 wt % of at least one of cellulose acetate, cellulose triacetate, cellulose propionate, cellulose butyrate, cellulose acetate propionate, cellulose acetate butyrate, cellulose propionate butyrate, and mixtures thereof; (b) 0-30 wt % of a plasticizer; (c) 0-10 wt % ethylene methyl acrylate copolymer; and (d) 1-20 wt % of an impact modifier; and (2) 1-30 wt % of hollow glass microspheres.

One embodiment of the present disclosure is a film or film layer comprising a polymer composition comprising (1) 70-99 wt % of a polyester composition which comprises (A) 5-80% of at least one crystallizable polyester which comprises: (a) a dicarboxylic acid component comprising: (i) 70 to 100 mole % of terephthalic acid residues; (ii) 0 to 30 mole % of aromatic and/or aliphatic dicarboxylic acid residues having up to 20 carbon atoms; and (b) a glycol component comprising: 75 mole % or greater of ethylene glycol residues and 25 mole % or less of other glycols comprising one or more of: (i) 0 to less than 25 mole % neopentyl glycol residues; (ii) 0 to less than 25 mole % 1,4-cyclohexanedimethanol residues; (iii) 0 to less than 10 mole % total diethylene glycol residues, whether or not formed in situ; wherein the total mole % of the dicarboxylic acid component is 100 mole %, and wherein the total mole % of the glycol component is 100 mole %; and (B) 20-95% of at least one amorphous polyester which comprises: (a) a dicarboxylic acid component comprising: (i) 70 to 100 mole % of terephthalic acid residues; (ii) 0 to 30 mole % of aromatic and/or aliphatic dicarboxylic acid residues having up to 20 carbon atoms; and (b) a glycol component comprising: 60 mole % or greater of ethylene glycol residues and 40 mole % or less of other glycols comprising one or more of: (i) 0 to less than 40 mole % neopentyl glycol residues; (ii) 0 to less than 40 mole % 1,4-cyclohexanedimethanol residues; (iii) 0 to less than 15 mole % total diethylene glycol residues, whether or not formed in situ; wherein the total mole % of the dicarboxylic acid component is 100 mole %, and wherein the total mole % of the glycol component is 100 mole %; and (2) 1-30 wt % of hollow glass microspheres.

One embodiment of the present disclosure is a film comprising a polymer blend comprising: (1) 70-99% of a polymer blend comprising: (a) 5-95 wt % of a polymer composition comprising at least one polymer selected from acrylic polymers, polyolefins, cellulose esters, cellulose acetate, cellulose triacetate, cellulose propionate, cellulose butyrate, cellulose acetate propionate, cellulose acetate butyrate, cellulose propionate butyrate, cyclic olefin copolymers, ethylene methyl acrylate copolymer, polycarbonate, polypropylene, polystyrene, polystyrene butadiene copolymers or blends, polyethylene, ethylene/propylene copolymer, ethylene-vinyl acetate (EVA), ethylene vinyl alcohol copolymer, polyvinyl chloride, poly(lactic acid), polyvinylidene chloride, nylon, polyethylene terephthalate (PET), polyesters, copolyesters, and mixtures thereof; and (b) 5-95 wt % of at least one polymer selected from acrylic polymers, polyolefins, cellulose esters, cellulose acetate, cellulose triacetate, cellulose propionate, cellulose butyrate, cellulose acetate propionate, cellulose acetate butyrate or cellulose propionate butyrate, cellulose acetate, cellulose triacetate, cellulose butyrate, cellulose propionate, cyclic olefin copolymers, ethylene methyl acrylate copolymer, polycarbonate, polypropylene, polystyrene, polystyrene butadiene copolymers or blends, polyethylene, ethylene/propylene copolymer, ethylene-vinyl acetate (EVA), ethylene vinyl alcohol copolymer, polyvinyl chloride, poly(lactic acid), polyvinylidene chloride, nylon, polyethylene terephthalate (PET), polyesters, copolyesters, and mixtures thereof; and (2) 1-30 wt % of hollow glass microspheres.

One embodiment of the present disclosure is a multilayer or laminate film comprising: (A) at least one layer (layer A) comprising a polymer composition comprising at least one polymer selected from acrylic polymers, polyolefins, cellulose esters, cellulose acetate, cellulose triacetate, cellulose propionate, cellulose butyrate, cellulose acetate propionate, cellulose acetate butyrate, cellulose propionate butyrate, cyclic olefin copolymers, ethylene methyl acrylate copolymer, polycarbonate, polypropylene, polystyrene, polystyrene butadiene copolymers or blends, polyethylene, ethylene/propylene copolymer, ethylene-vinyl acetate (EVA), ethylene vinyl alcohol copolymer, polyvinyl chloride, poly(lactic acid), polyvinylidene chloride, nylon, polyethylene terephthalate (PET), polyesters, copolyesters, and mixtures thereof; and (B) at least one voided layer (layer B) comprising (1) 70-99 wt % of a polymer composition comprising at least one polymer selected from acrylic polymers, polyolefins, cellulose esters, cellulose acetate, cellulose triacetate, cellulose propionate, cellulose butyrate, cellulose acetate propionate, cellulose acetate butyrate, cellulose propionate butyrate, cyclic olefin copolymers, ethylene methyl acrylate copolymer, polycarbonate, polypropylene, polystyrene, polystyrene butadiene copolymers or blends, polyethylene, ethylene/propylene copolymer, ethylene-vinyl acetate (EVA), ethylene vinyl alcohol copolymer, polyvinyl chloride, poly(lactic acid), polyvinylidene chloride, nylon, polyethylene terephthalate (PET), polyesters, copolyesters, and mixtures thereof; and (2) 1-30 wt % of hollow glass microspheres; and optionally (C) a tie layer or adhesive between the layers of the film.

One embodiment of the present disclosure is a multilayer or laminate film comprising: A. at least one layer (layer A) comprising a polymer composition comprising at least one polymer selected from acrylic polymers, polyolefins, cellulose esters, cellulose acetate, cellulose triacetate, cellulose propionate, cellulose butyrate, cellulose acetate propionate, cellulose acetate butyrate, cellulose propionate butyrate, cyclic olefin copolymers, ethylene methyl acrylate copolymer, polycarbonate, polypropylene, polystyrene, polystyrene butadiene copolymers or blends, polyethylene, ethylene/propylene copolymer, ethylene-vinyl acetate (EVA), ethylene vinyl alcohol copolymer, polyvinyl chloride, poly(lactic acid), polyvinylidene chloride, nylon, polyethylene terephthalate (PET), polyesters, copolyesters, and mixtures thereof; and B. at least one voided layer (layer B) comprising (1) 70-99 wt % of a polymer composition comprising at least one polymer selected from acrylic polymers, polyolefins, cellulose esters, cellulose acetate, cellulose triacetate, cellulose propionate, cellulose butyrate, cellulose acetate propionate, cellulose acetate butyrate, cellulose propionate butyrate, cyclic olefin copolymers, ethylene methyl acrylate copolymer, polycarbonate, polypropylene, polystyrene, polystyrene butadiene copolymers or blends, polyethylene, ethylene/propylene copolymer, ethylene-vinyl acetate (EVA), ethylene vinyl alcohol copolymer, polyvinyl chloride, poly(lactic acid), polyvinylidene chloride, nylon, polyethylene terephthalate (PET), polyesters, copolyesters, and mixtures thereof; and (2) 1-30 wt % of hollow glass microspheres; and C. optionally, at least one tie layer or adhesive layer between the layers of the film.

One embodiment of the present disclosure is a multilayer film comprising: A. at least one non-voided layer (layer A) comprising a polymer composition comprising at least one polymer selected from acrylic polymers, polyolefins, cellulose esters, cellulose acetate, cellulose triacetate, cellulose propionate, cellulose butyrate, cellulose acetate propionate, cellulose acetate butyrate, cellulose propionate butyrate, cyclic olefin copolymers, ethylene methyl acrylate copolymer, polycarbonate, polypropylene, polystyrene, polystyrene butadiene copolymers or blends, polyethylene, ethylene/propylene copolymer, ethylene-vinyl acetate (EVA), ethylene vinyl alcohol copolymer, polyvinyl chloride, poly(lactic acid), polyvinylidene chloride, nylon, polyethylene terephthalate (PET), polyesters, copolyesters, and mixtures thereof; wherein the density of the non-voided layer A is 1.3 g/cc or less, and B. at least one voided layer (layer B) comprising (1) 70-99 wt % of a polymer composition comprising at least one polymer selected from acrylic polymers, polyolefins, cellulose esters, cellulose acetate, cellulose triacetate, cellulose propionate, cellulose butyrate, cellulose acetate propionate, cellulose acetate butyrate, cellulose propionate butyrate, cyclic olefin copolymers, ethylene methyl acrylate copolymer, polycarbonate, polypropylene, polystyrene, polystyrene butadiene copolymers or blends, polyethylene, ethylene/propylene copolymer, ethylene-vinyl acetate (EVA), ethylene vinyl alcohol copolymer, polyvinyl chloride, poly(lactic acid), polyvinylidene chloride, nylon, polyethylene terephthalate (PET), polyesters, copolyesters, and mixtures thereof; and (2) 1-30 wt % of hollow glass microspheres; wherein the density of the voided layer B is 0.90 g/cc or less and C. at least one voided layer (layer C) comprising (1) 70-99 wt % of a polymer composition comprising at least one polymer selected from acrylic polymers, polyolefins, cellulose esters, cellulose acetate, cellulose triacetate, cellulose propionate, cellulose butyrate, cellulose acetate propionate, cellulose acetate butyrate, cellulose propionate butyrate, cyclic olefin copolymers, ethylene methyl acrylate copolymer, polycarbonate, polypropylene, polystyrene, polystyrene butadiene copolymers or blends, polyethylene, ethylene/propylene copolymer, ethylene-vinyl acetate (EVA), ethylene vinyl alcohol copolymer, polyvinyl chloride, poly(lactic acid), polyvinylidene chloride, nylon, polyethylene terephthalate (PET), polyesters, copolyesters, and mixtures thereof; and (2) optionally 1-30 wt % of hollow glass microspheres; wherein the density of the voided layer C is 1.2 g/cc or less, and D. optionally, at least one tie-layer or adhesive layer between the layers of the film.

### BRIEF DESCRIPTION OF THE DRAWINGS

FIG. 1 Shrink Curve of Floatable Shrink Films (Example 28) and the Control (resin 5).

FIG. 2 Transmittance Spectra of the shrinkable film made using concentrate 1.

FIG. 3 SEM image of a voided polyester film made with acrylic beads.

FIG. 4 SEM image of an ABA Multilayer film with 2 non-voided cap layers (A) adjacent to a voided layer (B) after shrinkage (Example 31).

FIG. 5 SEM image of a shrinkable, voided monolayer film before shrinkage (Example 28).

FIG. 6 SEM Image (A.) shows the voids created around the hollow glass microspheres after stretching and (B.) shows the cavity created by the immiscible polymers.

FIG. 7 SEM image of an ABC Multilayer film with 2 voided layers (A and B) adjacent to a non-voided layer (C).

### DETAILED DESCRIPTION OF THE INVENTION

The present disclosure may be understood more readily by reference to the following detailed description of certain embodiments consistent with the present teachings and the working examples.

The voided shrinkable films of the present disclosure exhibit high shrinkage and maintain a low density after shrinkage. Thus, the present disclosure provides a voided shrinkable film comprising an oriented, polyester having dispersed therein about 1 to about 50 weight percent (abbreviated herein as “wt %”) of a voiding agent wherein the film has a shrinkage of at least 20% or at least 40% and a density less than 1.0 g/cc. The shrinkable films in the present disclosure retains a low density after the shrinkage that typically occurs during a plastics recycling process. The film can be removed in sink/float separations that typically occur at the end of the recycling processes and, thus, is recycle friendly. A shrinkage of 20% or more, or shrinkage of 40% or more makes the film of the disclosure particularly useful for shrinkable label applications.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present disclosure. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10. Also, a range associated with chemical substituent groups such as, for example, “C1 to C5 hydrocarbons”, is intended to specifically include and disclose C1 and C5 hydrocarbons as well as C2, C3, and C4 hydrocarbons.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “voids”, “micro-voids”, “cavity” and “microporous”, as used herein, are intended to be synonymous and are well-understood by persons skilled in the art to mean tiny, discrete voids or pores contained within the polymer below the surface of the article that are intentionally created during the manufacture of the article. Similarly, the terms “voided”, “micro-voided”, “cavitated” and “micro-void containing”, as used herein in reference to the compositions, polymers, and films of the disclosure, are intended to be synonymous and mean “containing tiny, discrete voids or pores”. The film of the disclosure includes a “voiding agent” dispersed within the polyester. The term “voiding agent”, as used herein, is synonymous with the terms “voiding composition”, “micro-voiding agent”, and “cavitation agent” and is understood to mean a substance dispersed within a polymer matrix that is useful to bring about or cause the formation voids within the polymer matrix upon orientation or stretching of the polymer matrix. The term “polymer matrix” or “resin matrix”, as used herein, are synonymous with the terms “matrix polymer” and “matrix resin” and refers to one or more polymers providing a continuous phase in which the voiding again may be dispersed such that the particles of the voiding agent are surrounded and contained by the continuous phase. In one embodiment of the present disclosure, the polymer matrix is one or more polyesters. The term “film”, as used herein, includes both film and sheet, and is intended to have its commonly accepted meaning in the art. The term “film” is also understood to include both single layer and multilayer films. The term “shrink film” or “shrinkable film”, as used herein, includes any heat-shrinkable films or labels including wrap around labels, sleeve labels, shrink sleeve labels, and shrink wrap labels, and is intended to have its commonly accepted meaning in the art. The term “shrink film” or “shrinkable film” is also understood to include both single layer and multilayer shrink films.

The present disclosure may be understood more readily by reference to the following detailed description of certain embodiments of this disclosure and the working examples. In accordance with the purpose(s) of this disclosure, certain embodiments of this disclosure are described in the Summary of the Invention and are further described herein below. Also, other embodiments of the present disclosure are described herein.

Polymer and Polyester Compositions

The void containing films of the present disclosure may comprise various polymers and/or polyester compositions.

One embodiment of the present disclosure is a voided film comprising (1) polymers selected from acrylic polymers, polyolefins, cellulose esters, cellulose acetate, cellulose triacetate, cellulose propionate, cellulose butyrate, cellulose acetate propionate, cellulose acetate butyrate, cellulose propionate butyrate, cyclic olefin copolymers, ethylene methyl acrylate copolymer, polycarbonate, polypropylene, polystyrene, polystyrene butadiene copolymers or blends, polyethylene, ethylene/propylene copolymer, ethylene-vinyl acetate (EVA), ethylene vinyl alcohol copolymer, polyvinyl chloride, poly(lactic acid), polyvinylidene chloride, nylon, polyethylene terephthalate (PET), polyesters, copolyesters, and mixtures thereof; and (2) hollow glass microspheres.

One embodiment of the present disclosure is a voided film comprising (1) 50-99 wt % of at least one polymer selected from acrylic polymers, polyolefins, cellulose esters, cellulose acetate, cellulose triacetate, cellulose propionate, cellulose butyrate, cellulose acetate propionate, cellulose acetate butyrate, cellulose propionate butyrate, cyclic olefin copolymers, ethylene methyl acrylate copolymer, polycarbonate, polypropylene, polystyrene, polystyrene butadiene copolymers or blends, polyethylene, ethylene/propylene copolymer, ethylene-vinyl acetate (EVA), ethylene vinyl alcohol copolymer, polyvinyl chloride, poly(lactic acid), polyvinylidene chloride, nylon, polyethylene terephthalate (PET), polyesters, copolyesters, and mixtures thereof; and (2) 1-50 wt % of hollow glass microspheres.

One embodiment of the present disclosure is a voided film comprising (1) 70-99 wt % of at least one polymer selected from acrylic polymers, polyolefins, cellulose esters, cellulose acetate, cellulose triacetate, cellulose propionate, cellulose butyrate, cellulose acetate propionate, cellulose acetate butyrate, cellulose propionate butyrate, cyclic olefin copolymers, ethylene methyl acrylate copolymer, polycarbonate, polypropylene, polystyrene, polystyrene butadiene copolymers or blends, polyethylene, ethylene/propylene copolymer, ethylene-vinyl acetate (EVA), ethylene vinyl alcohol copolymer, polyvinyl chloride, poly(lactic acid), polyvinylidene chloride, nylon, polyethylene terephthalate (PET), polyesters, copolyesters, and mixtures thereof; and (2) 1-30 wt % of hollow glass microspheres.

In some embodiments, at least one polymer comprises a polyester. In other embodiments, at least one polymer comprises a polymer composition which comprises at least one polymer and at least one polyester

The term “polyester”, as used herein, is intended to include “copolyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds, for example, branching agents. Typically, the difunctional carboxylic acid can be a dicarboxylic acid and the difunctional hydroxyl compound can be a dihydric alcohol, for example, glycols and diols. The term “glycol” as used herein includes, but is not limited to, diols, glycols, and/or multifunctional hydroxyl compounds, for example, branching agents. Alternatively, the difunctional carboxylic acid may be a hydroxy carboxylic acid, for example, p-hydroxybenzoic acid, and the difunctional hydroxyl compound may have an aromatic nucleus bearing 2 hydroxyl substituents, for example, hydroquinone. The term “residue”, as used herein, means any organic structure incorporated into a polymer through a polycondensation and/or an esterification reaction from the corresponding monomer. The term “repeating unit”, as used herein, means an organic structure having a dicarboxylic acid residue and a diol residue bonded through an ester group. Thus, for example, the dicarboxylic acid residues may be derived from a dicarboxylic acid monomer or its associated acid halides, esters, salts, anhydrides, and/or mixtures thereof. Furthermore, as used herein, the term “diacid” includes multifunctional acids, for example, branching agents. As used herein, therefore, the term “dicarboxylic acid” is intended to include dicarboxylic acids and any derivative of a dicarboxylic acid, including its associated acid halides, esters, half-esters, salts, half-salts, anhydrides, mixed anhydrides, and/or mixtures thereof, useful in a reaction process with a diol to make a polyester. As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, and/or mixtures thereof or residues thereof useful in a reaction process with a diol to make a polyester.

In one embodiment, the polyesters may be prepared by conventional polycondensation procedures well-known in the art. Such processes include direct condensation of the dicarboxylic acid(s) with the diol(s) or by ester interchange using a dialkyl dicarboxylate. For example, a dialkyl terephthalate such as dimethyl terephthalate is ester interchanged with the diol(s) at elevated temperatures in the presence of a catalyst. The polyesters may also be subjected to solid-state polymerization methods. Suitable methods include the steps of reacting one or more dicarboxylic acids with one or more glycols at a temperature of 100° C. to 315° C. at a pressure of 0.1 to 760 mm Hg for a time sufficient to form a polyester. See U.S. Pat. No. 3,772,405 for methods of producing polyesters, the disclosure of such methods which is incorporated herein by reference.

In one embodiment, the polyesters used in the present disclosure can be prepared from dicarboxylic acids and diols which react in substantially equal proportions and are incorporated into the polyester polymer as their corresponding residues. The polyesters of the present disclosure, therefore, can contain substantially equal molar proportions of acid residues (100 mole %) and diol (and/or multifunctional hydroxyl compound) residues (100 mole %) such that the total moles of repeating units is equal to 100 mole %. The mole percentages provided in the present disclosure, therefore, may be based on the total moles of acid residues, the total moles of diol residues, or the total moles of repeating units. For example, a polyester containing 10 mole % isophthalic acid, based on the total acid residues, means the polyester contains 10 mole % isophthalic acid residues out of a total of 100 mole % acid residues. Thus, there are 10 moles of isophthalic acid residues among every 100 moles of acid residues. In another example, a polyester containing 25 mole % 1,4-cyclohexanedimethanol, based on the total diol residues, means the polyester contains 25 mole % 1,4-cyclohexanedimethanol residues out of a total of 100 mole % diol residues. Thus, there are 25 moles of 1,4-cyclohexanedimethanol residues among every 100 moles of diol residues.

In certain embodiments, terephthalic acid or an ester thereof, for example, dimethyl terephthalate or a mixture of terephthalic acid residues and an ester thereof can make up a portion or all of the dicarboxylic acid component used to form the polyesters useful in the present disclosure. In certain embodiments, terephthalic acid residues can make up a portion or all of the dicarboxylic acid component used to form the polyesters useful in this disclosure. For the purposes of this disclosure, the terms “terephthalic acid” and “dimethyl terephthalate” are used interchangeably herein. In one embodiment, dimethyl terephthalate is part or all of the dicarboxylic acid component used to make the polyesters useful in the present disclosure. In embodiments, ranges of from 70 to 100 mole %; or 80 to 100 mole %; or 90 to 100 mole %; or 99 to 100 mole %; or 100 mole % terephthalic acid and/or dimethyl terephthalate and/or mixtures thereof may be used.

In addition to terephthalic acid, the dicarboxylic acid component of the polyesters useful in the present disclosure can comprise up to 30 mole %, up to 20 mole %, up to 10 mole %, up to 5 mole %, or up to 1 mole % of one or more modifying aromatic dicarboxylic acids. Yet another embodiment contains 0 mole % modifying aromatic dicarboxylic acids. Thus, if present, it is contemplated that the amount of one or more modifying aromatic dicarboxylic acids can range from any of these preceding endpoint values including, for example, 0.01 to 10 mole %, from 0.01 to 5 mole % and from 0.01 to 1 mole %. In one embodiment, modifying aromatic dicarboxylic acids that may be used in the present disclosure include but are not limited to those having up to 20 carbon atoms, and which can be linear, para-oriented, or symmetrical. Examples of modifying aromatic dicarboxylic acids which may be used in this disclosure include, but are not limited to, isophthalic acid, 4,4′-biphenyldicarboxylic acid, 1,4-, 1,5-, 2,6-, 2,7-naphthalenedicarboxylic acid, and trans-4,4′-stilbenedicarboxylic acid, and esters thereof. In one embodiment, the modifying aromatic dicarboxylic acid is isophthalic acid.

The carboxylic acid component of the polyesters useful in the present disclosure can be further modified with up to 10 mole %, such as up to 5 mole % or up to 1 mole % of one or more aliphatic dicarboxylic acids containing 2-16 carbon atoms, for example, cyclohexanedicarboxylic, malonic, succinic, glutaric, adipic, pimelic, suberic, azelaic and/or dodecanedioic dicarboxylic acids. Certain embodiments can also comprise 0.01 to 10 mole %, such as 0.1 to 10 mole %, 1 or 10 mole %, 5 to 10 mole % of one or more modifying aliphatic dicarboxylic acids. Yet another embodiment contains 0 mole % modifying aliphatic dicarboxylic acids. The total mole % of the dicarboxylic acid component is 100 mole %. In one embodiment, adipic acid and/or glutaric acid are provided in the modifying aliphatic dicarboxylic acid component of the polyesters and are useful in the present disclosure.

Esters of terephthalic acid and the other modifying dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and phenyl esters.

In most embodiments, the glycol (or diol) component of the polyester portion of the polyester compositions useful in the present disclosure as defined herein contain 2 to 16 carbon atoms. Examples of suitable glycol (or diol) components include, but are not limited to, ethylene glycol (EG), cyclohexanedimethanol (CHDM), 2,2,4,4-tetramethyl-1,3-cyclobutanediol (TMCD), diethylene glycol (DEG), 1,2-propanediol, 1,3-propanediol, neopentyl glycol (NPG), isosorbide, 1,4-butanediol, 1,5-pentanediol, 1,6-hexanediol, p-xylene glycol, poly(tetramethylene glycol), and mixtures thereof. In one embodiment, isosorbide is a glycol component. In one embodiment, ethylene glycol (EG) is a glycol component. In one embodiment, neopentyl glycol (NPG) is a glycol component. In one embodiment, poly(tetramethylene glycol) is a glycol component. In one embodiment, cyclohexanedimethanol (CHDM) is a glycol component. In one embodiment, 2,2,4,4-tetramethyl-1,3-cyclobutanediol (TMCD) is a glycol component. In one embodiment, diethylene glycol (DEG) is a glycol component. In one embodiment, poly(tetramethylene glycol) (PTMG) is a glycol component. In another embodiment, the glycol component includes, but is not limited to, at least one of 1,3-propanediol and 1,4-butanediol. In one embodiment, 1,3-propanediol and/or 1,4-butanediol can be excluded. If 1,4- or 1,3-butanediol are used, greater than 4 mole % or greater than 5 mole % can be provided in one embodiment. In one embodiment, at least one glycol component is 1,4-butanediol which present in the amount of 5 to 25 mole %. In one embodiment, ethylene glycol (EG), cyclohexanedimethanol (CHDM), 2,2,4,4-tetramethyl-1,3-cyclobutanediol (TMCD), neopentyl glycol (NPG), poly(tetramethylene glycol) (PTMG), and diethylene glycol (DEG) are the glycol components.

In one embodiment, the glycol (or diol) component of the polyester portion of the polyester compositions useful in the present disclosure as defined herein is 2,2,4,4-tetramethyl-1,3-cyclobutanediol. In one embodiment, at least one glycol component is 2,2,4,4-tetramethyl-1,3-cyclobutanediol. In one embodiment, 2,2,4,4-tetramethyl-1,3-cyclobutanediol is added, in any amount, for example, in the amount of 0 to 60 mole %, or 0 to 50 mole %, or 0 to 45 mole %, or 0 to 40 mole %, or 0 to 30 mole %, or 0 to 20 mole %, or 0 to 10 mole %, or 0 to 5 mole %, 0.01 to 5 mole %, 0.01 to 10 mole %, or 0.01 to 20 mole %, or 0.1 to 30 mole %, or 0.1 to 40 mole %, or 0.1 to 45 mole %, 0.1 to 50 mole %, or 1 to 10 mole %, or 1 to 20 mole %, 1 to 30 mole %, 1 to 40 mole %, 1 to 45 mole %, or 2 to 5 mole % or 2 to 10 mole %, 2 to 15 mole %, or 10 to 15 mole %, 10 to 20 mole %, or 10 to 30 mole %, or 10 to 45 mole %, or 15 to 20 mole %, or 15 to 25 mole %, 15 to 30 mole %, 15 to 35 mole %, 20 to 35 mole %, 20 to 40 mole %, or 12 to 25 mole %. In one embodiment, the polyesters useful in this disclosure can comprise 2,2,4,4-tetramethyl-1,3-cyclobutanediol in the amount of less than 50 mole %. In one embodiment, the polyesters useful in this disclosure can comprise 2,2,4,4-tetramethyl-1,3-cyclobutanediol in the amount of less than 45 mole %. In one embodiment, the polyesters useful in this disclosure can comprise 2,2,4,4-tetramethyl-1,3-cyclobutanediol in the amount of less than 40 mole %. In one embodiment, the polyesters useful in this disclosure can comprise 2,2,4,4-tetramethyl-1,3-cyclobutanediol in the amount of less than 30 mole %. In one embodiment, the polyesters useful in this disclosure can comprise 2,2,4,4-tetramethyl-1,3-cyclobutanediol in the amount of less than 20 mole %. In one embodiment, the polyesters useful in this disclosure can comprise 2,2,4,4-tetramethyl-1,3-cyclobutanediol in the amount of less than 10 mole %.

In some embodiments, for the desired polyester, the molar ratio of cis/trans 2,2,4,4-tetramethyl-1,3-cyclobutanediol can vary from the pure form of each and mixtures thereof. In certain embodiments, the molar percentages for cis and/or trans 2,2,4,4,-tetramethyl-1,3-cyclobutanediol are greater than 50 mole % cis and less than 50 mole % trans; or greater than 55 mole % cis and less than 45 mole % trans; or 50 to 70 mole % cis and 50 to 30 mole % trans; or 60 to 70 mole % cis and 30 to 40 mole % trans; or greater than 70 mole % cis and less than 30 mole % trans; wherein the total mole percentages for cis- and trans-2,2,4,4-tetramethyl-1,3-cyclobutanediol is equal to 100 mole %. In an additional embodiment, the molar ratio of cis/trans 2,2,4,4-tetramethyl-1,3-cyclobutanediol can vary within the range of 50/50 to 0/100, for example, between 40/60 to 20/80.

In one embodiment, the glycol (or diol) component of the polyester portion of the polyester compositions useful in the present disclosure as defined herein is 1,4-cyclohexanedimethanol. In one embodiment, at least one glycol component is 1,4-cyclohexanedimethanol. In one embodiment, 1,4-cyclohexanedimethanol is added, in any amount, for example, in the amount of 0 to 100 mole %, 0 to 90 mole %, 0 to 80 mole %, 0 to 70 mole %, 0 to 60 mole %, or 0 to 50 mole %, or 0 to 40 mole %, or 0 to 30 mole %, or 0 to 20 mole %, or 0 to 10 mole %, or 0 to 5 mole %, 0.01 to 5 mole %, 0.01 to 8 mole %, or 0.01 to 10 mole %, 0.01 to 20 mole %, or 0.01 to 30 mole %, or 0.01 to 40 mole %, or 0.01 to 50 mole %, or 0.01 to 60 mole %, or 0.01 to 80 mole or 0.85 to 8 mole %, or 1 to 8 mole %, or 1 to 5 mole %, 1 to 3 mole % or 2 to 5 mole % or 2 to 10 mole %, 2 to 15 mole %, or 10 to 15 mole %, 10 to 20 mole % or 10 to 30 mole % or 15 to 20 mole %, or 15 to 25 mole %, 15 to 30 mole % or 12 to 25 mole %. In one embodiment, the polyesters useful in this disclosure can comprise 1,4-cyclohexanedimethanol in the amount of less than 80 mole %. In one embodiment, the polyesters useful in this disclosure can comprise 1,4-cyclohexanedimethanol in the amount of less than 60 mole %. In one embodiment, the polyesters useful in this disclosure can comprise 1,4-cyclohexanedimethanol in the amount of less than 50 mole %. In one embodiment, the polyesters useful in this disclosure can comprise 1,4-cyclohexanedimethanol in the amount of less than 40 mole %. In one embodiment, the polyesters useful in this disclosure can comprise 1,4-cyclohexanedimethanol in the amount of less than 30 mole %. In one embodiment, the polyesters useful in this disclosure can comprise 1,4-cyclohexanedimethanol in the amount of less than 20 mole %. In one embodiment, the polyesters useful in this disclosure can comprise 1,4-cyclohexanedimethanol in the amount of less than 10 mole %. In one embodiment, the polyesters useful in this disclosure can comprise 1,4-cyclohexanedimethanol in the amount of less than 5 mole %. In another embodiment, the polyesters useful in this disclosure comprise 1,4-cyclohexanedimethanol and 1,3-cyclohexanedimethanol. The molar ratio of cis/trans 1,4-cyclohexanedimethanol can vary within the range of 50/50 to 0/100, for example, between 40/60 to 20/80.

In one embodiment, the glycol (or diol) component of the polyester portion of the polyester compositions useful in the present disclosure as defined herein is 2,2-dimethylpropane-1,3-diol (neopentyl glycol or NPG). In one embodiment, at least one glycol component is 2,2-dimethylpropane-1,3-diol (neopentyl glycol or NPG). In one embodiment, 2,2-dimethylpropane-1,3-diol (neopentyl glycol or NPG) is added, in any amount, for example, in the amount of 0 to 100 mole %, or 0 to 50 mole %, or 0 to 40 mole %, or 0 to 30 mole %, or 0 to 20 mole %, or 0 to 15 mole %, or 0 to 10 mole %, or 0 to 5 mole %, 0.01 to 5 mole %, 0.01 to 10 mole %, or 0.1 to 15 mole %, or 0.01 to 20 mole %, 0.01 to 40 mole %, or 1 to 20 mole %, or 1 to 40 mole %, or 5 to 40 mole %, or 5 to 20 mole %, 10 to 15 mole %, or 10 to 20 mole %, or 5 to 15 mole %, or 1 to 15 mole % or 2 to 15 mole % or 2 to 10 mole %. In one embodiment, the polyesters useful in this disclosure can comprise 2,2-dimethylpropane-1,3-diol in the amount of less than 40 mole %. In one embodiment, the polyesters useful in this disclosure can comprise 2,2-dimethylpropane-1,3-diol in the amount of less than 30 mole %. In one embodiment, the polyesters useful in this disclosure can comprise 2,2-dimethylpropane-1,3-diol in the amount of less than 20 mole %. In one embodiment, the polyesters useful in this disclosure can comprise 2,2-dimethylpropane-1,3-diol in the amount of less than 15 mole %.

In one embodiment, the glycol (or diol) component of the polyester portion of the polyester compositions useful in the present disclosure as defined herein is diethylene glycol. In one embodiment, at least one glycol component is diethylene glycol. In one embodiment, the diethylene glycol is not added as a separate monomer but is formed during polymerization. In one embodiment, the diethylene glycol is added as a separate monomer. In one embodiment, diethylene glycol residues can be present in the polyester useful in this disclosure, whether or not formed in situ during processing or intentionally added, in any amount, for example, in the amount of 0 to 50 mole %, or 0 to 40 mole %, or 0 to 30 mole %, or 0 to 20 mole %, or 0 to 15 mole %, or 0 to 10 mole %, or 0 to 5 mole %, 0.01 to 5 mole %, 0.01 to 10 mole %, or 0.01 to 15 mole %, or 0.01 to 8 mole %, 1 to 5 mole %, or 1 to 8 mole %, or 1 to 10 mole %, or 1 to 15 mole %, or 1 to 20 mole %, or 2 to 5 mole %, 2 to 10 mole %, 2 to 15 mole %, 2 to 20 mole %, or 3 to 5 mole %, or 5 to 10 mole %, or 5 to 8 mole %, or 5 to 15 mole % or 3 to 10 mole % or 3 to 15 mole %. In one embodiment, the polyesters useful in this disclosure can comprise diethylene glycol in the amount of less than 40 mole %. In one embodiment, the polyesters useful in this disclosure can comprise diethylene glycol in the amount of less than 30 mole %. In one embodiment, the polyesters useful in this disclosure can comprise diethylene glycol in the amount of less than 20 mole %. In one embodiment, the polyesters useful in this disclosure can comprise diethylene glycol in the amount of less than 15 mole %. In one embodiment, the polyesters useful in this disclosure can comprise diethylene glycol in the amount of less than 10 mole %. In one embodiment, the polyesters useful in this disclosure can comprise 1,4-cyclohexanedimethanol in the amount of less than 5 mole %.

For most embodiments, the remainder glycol (or diol) component of the polyester portion of the polyester compositions useful in the present disclosure as defined herein can comprise ethylene glycol residues in any amount based on the total mole % of the glycol (or diol) component being 100 mole %. In one embodiment, the polyester portion of the polyester compositions useful in the present disclosure can contain 100 mole % of ethylene glycol residues, based on the total mole % of the diol component being 100 mole %. In one embodiment, the polyester portion of the polyester compositions useful in the present disclosure can contain 50 mole % or greater, or 55 mole % or greater, or 60 mole % or greater, or 65 mole % or greater, or 70 mole % or greater, or 75 mole % or greater, or 80 mole % or greater, or 85 mole % or greater, or 90 mole % or greater, or 95 mole % or greater, or from 50 to 90 mole %, or from 50 to 85 mole %, or from 50 to 80 mole %, or from 55 to 80 mole %, or from 60 to 80 mole %, or from 50 to 75 mole %, or from 55 to 75 mole %, or from 60 to 75 mole %, or from 65 to 75 mole % of ethylene glycol residues, based on the total mole % of the diol component being 100 mole %.

In some embodiments, the glycol component of the polyesters may optionally include other modifying glycols (or diols), if used, as defined herein, that contain 2 to 16 carbon atoms. Examples of other modifying glycols (or diols) include, but are not limited to, cyclohexanedimethanol (CHDM), 2,2,4,4-tetramethyl-1,3-cyclobutanediol (TMCD), diethylene glycol (DEG), 1,2-propanediol, 1,3-propanediol, neopentyl glycol (NPG), isosorbide, 1,4-butanediol, 1,5-pentanediol, 1,6-hexanediol, p-xylene glycol, poly(tetramethylene glycol), and mixtures thereof. In some embodiments, the glycol component of the polyester portion of the polyester compositions useful in the present disclosure can contain up to 30 mole %, or 20 mole %, or 15 mole %, or 10 mole %, or 9 mole %, or 8 mole %, or 7 mole %, or 6 mole %, or 5 mole %, or 4 mole %, or 3 mole %, or 2 mole %, or 1 mole %, or less of one or more other modifying glycols. In one embodiment, the other modifying glycols can be added, in any amount, for example, in the amount of 0 to 40 mole %, or 0 to 30 mole %, or 0 to 20 mole %, or 0 to 15 mole %, or 0 to 10 mole %, or 0 to 5 mole %. In one embodiment, the polyesters useful in this disclosure can comprise other modifying glycols an amount of less than 30 mole %. In one embodiment, the polyesters useful in this disclosure can comprise other modifying glycols in an amount of less than 20 mole %. In one embodiment, the polyesters useful in this disclosure can comprise other modifying glycols in an amount of less than 10 mole %. In one embodiment, the polyesters useful in this disclosure can comprise other modifying glycols in an amount of less than 5 mole %. In another embodiment, the polyesters useful in this disclosure can contain 0 mole % of other modifying glycols. It is contemplated however that some other glycol residuals may form in situ.

In one embodiment, at least one polymer comprises a copolyetherester composition comprising: at least one copolyetherester which comprises (a) an aliphatic dicarboxylic acid component comprising 1,4-cyclohexanedicarboxylic acid (b) a glycol component comprising: (i) from 95 to 70 mole percent 1,4-cyclohexanedimethanol, and (ii) from 3 to 30 mole percent of a polyalkyleneether glycol having a carbon to oxygen atom ratio of from 2 to 1 to 4 to 1 and a molecular weight of from 400 to 4000 (c) from 0.05 to 2 mole percent of branching agent comprising an acid, alcohol or mixture thereof having a functionality greater than 2.

In some embodiments, the polyesters according to the present disclosure can comprise from 0 to 10 mole %, for example, from 0.01 to 5 mole %, from 0.01 to 1 mole %, from 0.05 to 5 mole %, from 0.05 to 1 mole %, or from 0.1 to 0.7 mole %, based the total mole percentages of either the diol or diacid residues; respectively, of one or more residues of a branching monomer, also referred to herein as a branching agent, having 3 or more carboxyl substituents, hydroxyl substituents, or a combination thereof. In certain embodiments, the branching monomer or agent may be added prior to and/or during and/or after the polymerization of the polyester. In some embodiments, the polyester(s) useful in the present disclosure can thus be linear or branched.

When used, examples of branching monomers include, but are not limited to, multifunctional acids or multifunctional alcohols such as trimellitic acid, trimellitic anhydride, pyromellitic dianhydride, trimethylolpropane, glycerol, pentaerythritol, citric acid, tartaric acid, 3-hydroxyglutaric acid and the like. In one embodiment, the branching monomer residues can comprise 0.1 to 0.7 mole % of one or more residues chosen from at least one of the following: trimellitic anhydride, pyromellitic dianhydride, glycerol, sorbitol, 1,2,6-hexanetriol, pentaerythritol, trimethylolethane, and/or trimesic acid. The branching monomer may be added to the polyester reaction mixture or blended with the polyester in the form of a concentrate as described, for example, in U.S. Pat. Nos. 5,654,347 and 5,696,176, whose disclosure regarding branching monomers is incorporated herein by reference.

The polyesters useful in the present disclosure can comprise at least one chain extender. Suitable chain extenders include, but are not limited to, multifunctional (including, but not limited to, bifunctional) isocyanates, multifunctional epoxides, including, for example, epoxylated novolacs, and phenoxy resins. In certain embodiments, chain extenders may be added at the end of the polymerization process or after the polymerization process. If added after the polymerization process, chain extenders can be incorporated by compounding or by addition during conversion processes such as injection molding or extrusion.

The amount of chain extender used can vary depending on the specific monomer composition used and the physical properties desired but is generally 0.1 percent by weight to 10 percent by weight, such as 0.1 to 5 percent by weight, based on the total weight of the polyester.

It is contemplated that polyester compositions useful in the present disclosure can possess at least one of the inherent viscosity ranges described herein and at least one of the monomer ranges for the polyester compositions described herein, unless otherwise stated. It is also contemplated that polyester compositions useful in the present disclosure can possess at least one of the Tg ranges described herein and at least one of the monomer ranges for the polyester compositions described herein, unless otherwise stated. It is also contemplated that polyester compositions useful in the present disclosure can possess at least one of the inherent viscosity ranges described herein, at least one of the Tg ranges described herein, and at least one of the monomer ranges for the polyester compositions described herein, unless otherwise stated.

For embodiments of the present disclosure, the polyesters useful in this disclosure may exhibit at least one of the following inherent viscosities as determined in 60/40 (wt/wt) phenol/tetrachloroethane at a concentration of 0.25 g/50 ml at 25° C.: 0.50 to 1.2 dL/g; 0.50 to 1.0 dL/g; 0.50 to 0.90 dL/g; 0.50 to 0.80 dL/g; 0.50 to 0.75 dL/g; 0.50 to 0.70 dL/g; 0.50 to 0.68 dL/g; 0.55 to 0.80 dL/g; 0.55 to 0.75 dL/g; 0.55 to 0.70 dL/g; 0.55 to 0.68 dL/g; 0.57 to 0.68 dL/g; 0.58 to 0.67 dL/g; 0.58 to 0.66 dL/g; 0.59 to 0.66 dL/g; 0.60 to 0.75 dL/g, 0.60 to 0.72 dL/g, 0.60 to 0.70 dL/g, or 0.60 to 0.68 dL/g; 0.57 to 0.73 dL/g; 0.58 to 0.72 dL/g; 0.59 to 0.71 dL/g; 0.60 to 0.70 dL/g; 0.61 to 0.69 dL/g; 0.62 to 0.68 dL/g; 0.63 to 0.67 dL/g; 0.64 to 0.66 dL/g; or 0.65 dL/g.

The glass transition temperature (Tg) of the polyesters is determined using a TA DSC 2920 from Thermal Analyst Instrument at a scan rate of 20° C./min. Certain embodiments, comprise polyester compositions wherein the polyester has a Tg of −10 to 140° C.; −10 to 120° C.; 50 to 140° C.; 50 to 135° C.; 50 to 130° C.; 50 to 125° C., 50 to 120° C.; 50 to 115° C.; 50 to 110° C.; 50 to 105° C.; 50 to 100° C.; 50 to 95° C.; 50 to 85° C.; 50 to 80° C.; 60 to 140° C.; 60 to 135° C.; 60 to 130° C.; 60 to 125° C., 60 to 120° C.; 60 to 115° C.; 60 to 110° C.; 60 to 105° C.; 60 to 100° C.; 60 to 95° C.; 60 to 85° C.; 60 to 80° C.; 70 to 140° C.; 70 to 135° C.; 70 to 130° C.; 70 to 125° C., 70 to 120° C.; 70 to 115° C.; 70 to 110° C.; 70 to 105° C.; 70 to 100° C.; 70 to 95° C.; 70 to 85° C.; 70 to 80° C.; 80 to 140° C.; 80 to 135° C.; 80 to 130° C.; 80 to 125° C., 80 to 120° C.; 80 to 115° C.; 80 to 110° C.; 80 to 105° C.; 80 to 100° C.; 80 to 95° C.; 90 to 140° C.; 90 to 135° C.; 90 to 130° C.; 90 to 125° C., 90 to 120° C.; 90 to 115° C.; 95 to 110° C.; or 97 to 108° C.; or 97 to 106° C.; or 100 to 110° C.; or 100 to 108° C.; or 100 to 106° C.; or 102 to 110° C.; or 102 to 108° C.; or 102 to 106° C.; or 103 to 110° C.; or 103 to 108° C.; or 103 to 107° C.; or 103 to 106° C.; or 104 to 110° C.; or 104 to 108° C., or 104 to 107° C.; or 104 to 106° C., or 105° C.; 100 to 115° C.; 110 to 115° C.; or 80 to 115° C.; 80 to 105° C.; or 80 to 100° C., or 80 to less than 100° C., 80 to 99° C., or 80 to 98° C., or 80 to 97° C. or 80 to 96° C., or 80 to 95° C., or 80 to 94° C., or 80 to 93° C., or 85 to 105° C., or 85 to 100° C., or 85 to less than 100° C., or 85 to 99° C., or 85 to 98° C., or 85 to 97° C. or 85 to 96° C., or 85 to 95° C., or 85 to 94° C., or 85 to 93° C., or 86 to 100° C.; or 86 to less than 100° C., or 86 to 100° C.; or 86 to less than 100° C., or 86 to 99° C., or 86 to 98° C., or 86 to 97° C. or 86 to 96° C., or 86 to 95° C., or 86 to 94° C., or 86 to 93° C., or 87 to 99° C., or 87 to 98° C., or 87 to 97° C. or 87 to 96° C., or 87 to 95° C., or 87 to 94° C., or 87 to 93° C., or 88 to 99° C., or 88 to 98° C., or 88 to 97° C. or 88 to 96° C., or 88 to 95° C., or 88 to 94° C., or 88 to 93° C., or 90 to 95° C., or 91 to 95° C., or 92 to 94° C.

In certain embodiments of this disclosure, the Tg of the polyesters can be chosen from one of the following ranges: Tg of 50 to 110° C.; or 60 to 105° C.; or 65 to 100° C.; or 60 to less than 100° C.; or 65 to less than 100° C.; or 70 to 100° C.; 60 to 99° C.; 65 to 98° C.; 70 to 97° C.; 75 to 96° C.; 80 to 95° C.; 65 to 95° C.; 70 to 90° C.; −10 to 110° C.

In certain embodiments, these Tg ranges can be met with or without at least one plasticizer being added during polymerization or during processing or during compounding. In one embodiments, the Tg range can be met with at least one plasticizer being added during polymerization or during processing or during compounding. In one embodiments, the Tg range can be met without at least one plasticizer being added during polymerization or during processing or during compounding.

In certain embodiments, the oriented films or shrinkable films of the present disclosure comprise polyesters/polyester compositions wherein the polyester has a Tg of 60 to 120° C.; 60 to 80° C.; 70 to 80° C.; or 65 to 80° C.; or 65 to 75° C. In certain embodiments, these Tg ranges can be met with or without at least one plasticizer being added.

In one embodiment, the processes of making the polyesters useful in this disclosure can comprise a batch or continuous process.

This disclosure further relates to the polyester compositions made by the process(es) described above.

In one aspect of the present disclosure, blends of the amorphous polyesters with other polymers (including other polyesters and copolyesters) are suitable for use provided that the blend has a minimum crystallization half-time of at least about 5 minutes or greater. In one embodiment, the polyesters of this disclosure are not blends.

In one embodiment, the polyesters of the present disclosure are crystalline. In one embodiment, the polyesters of the present disclosure are semi-crystalline. In one embodiment, the polyesters of the present disclosure are amorphous. In one embodiment, the polyesters of the present disclosure are essentially amorphous.

In one embodiment, any amorphous, essentially amorphous, or semicrystalline polyesters are suitable for use in the present disclosure. In one aspect, certain polyesters useful in this disclosure can have a relatively low crystallinity. Certain polyesters useful in the present disclosure can thus have a substantially amorphous morphology, meaning that the polyesters comprise substantially unordered regions of polymer. For example, in one embodiment, any polyesters can be used in this disclosure provided that they are essentially amorphous and have a minimum crystallization half-time of at least about 5 minutes or greater. In one embodiment, the polyesters of this disclosure have a crystallization half time of at least 5 minutes or greater. The crystallization half time may be, for example, at least 7 minutes or greater, at least 10 minutes or greater, at least 12 minutes or greater, at least 20 minutes or greater, and at least 30 minutes or greater. The amorphous polyesters in the present disclosure can, in some embodiments, have crystallization half-times up to infinity.

In one embodiment, semicrystalline or crystalline polyesters are suitable for use in the present disclosure. In one aspect, certain polyesters useful in this disclosure can have a high level of crystallinity. In some embodiments, the polyesters are crystalline and have a crystallization half time of less than 1 minutes.

In some embodiments, a crystallizable polyester which exhibits crystallization and/or crystalline melting peak during a DSC scan during 1^{st} or 2^{nd} heat at a heating rate of 20° C./min. Amorphous polyesters typically do not have a crystalline melting point that can be measured on the 2^{nd} heat of the DSC scan with a heating rate of 20° C./min.

The crystallization half time of the polyester, as used herein, may be measured using conventional methods. For example, in one embodiment, the crystallization half time may be measured using a Perkin-Elmer Model DSC-2 differential scanning calorimeter. In one embodiment, crystallization half-times can be measured using a differential scanning calorimeter according to the following procedure. A sample of about 10.0 mg of the polyester is sealed in an aluminum pan and heated at a rate of about 20° C./min to about 290° C. and held for about 2 minutes in a helium atmosphere. The sample is then cooled immediately at a rate of about 20° C./min to an isothermal crystallization temperature ranging from about 140° C. to about 200° C. with about a 10° C. interval. The crystallization half-time at each temperature is then determined as the time needed to reach the peak on the exothermic curve. The minimum crystallization half-time is taken at the temperature at which the crystallization rate is the fastest.

In one embodiment, certain polyesters useful in this disclosure can exhibit at least one of the following densities: a density of greater than 1.2 g/ml at 23° C.

In embodiments of this disclosure, certain polyesters and/or polyester compositions of this disclosure can have a unique combination of all of the following properties: certain inherent viscosities, certain glass transition temperature (Tg), good color, and good mechanical properties.

In embodiments of the present disclosure, certain oriented films and/or shrinkable films comprising the polyesters and/or polyester compositions useful in this disclosure can have a unique combination of all of the following properties: controlled stretchability, controlled shrinkage properties, certain toughness, certain inherent viscosities, certain glass transition temperatures (Tg), certain densities, good shrink force, good light transmission or opacity, certain surface energy, good melt viscosity, and good color.

In one embodiment, certain polyester compositions useful in this disclosure can be visually clear before compounding. The term “visually clear” is defined herein as an appreciable absence of cloudiness, haziness, and/or muddiness, when inspected visually.

The polyester portion of the polyester compositions useful in this disclosure can be made by processes known from the literature, for example, by processes in homogenous solution, by transesterification processes in the melt, and by two phase interfacial processes. Suitable methods include, but are not limited to, the steps of reacting one or more dicarboxylic acids with one or more diols at a temperature of 100° C. to 315° C. at a pressure of 0.1 to 760 mm Hg for a time sufficient to form a polyester. See U.S. Pat. No. 3,772,405 for methods of producing polyesters, the disclosure regarding such methods is hereby incorporated herein by reference.

The polyester in general may be prepared by condensing the dicarboxylic acid or dicarboxylic acid ester with the diol in the presence of a catalyst at elevated temperatures increased gradually during the course of the condensation up to a temperature of 225° C. to 310° C., in an inert atmosphere, and conducting the condensation at low pressure during the latter part of the condensation, as described in further detail in U.S. Pat. No. 2,720,507 incorporated herein by reference herein.

In some embodiments, during the process for making the polyesters useful in the present disclosure, certain agents which colorize the polymer can be added to the melt including toners or dyes. In one embodiment, a bluing toner is added to the melt in order to adjust the b* of the resulting polyester polymer melt phase product. Such bluing agents include blue inorganic and organic toner(s) and/or dyes. In addition, red toner(s) and/or dyes can also be used to adjust the a* color. Organic toner(s), e.g., blue and red organic toner(s), such as those toner(s) described in U.S. Pat. Nos. 5,372,864 and 5,384,377, which are incorporated by reference in their entirety, can be used. The organic toner(s) can be fed as a premix composition. The premix composition may be a neat blend of the red and blue compounds or the composition may be pre-dissolved or slurried in one of the polyester's raw materials, e.g., ethylene glycol or added during polymerization or added during a separate compounding step.

The total amount of toner components added can depend on the amount of inherent color in the base polyester and the efficacy of the toner. In one embodiment, a concentration of up to 15 ppm of combined organic toner components and a minimum concentration of 0.5 ppm can be used. In one embodiment, the total amount of bluing additive can range from 0.5 to 10 ppm. In an embodiment, the toner(s) can be added to the esterification zone or to the polycondensation zone or added during processing or compounding. Preferably, the toner(s) are added to the esterification zone or to the early stages of the polycondensation zone, such as to a prepolymerization reactor.

The present disclosure further relates to polymer blends. In one embodiment, the polymer blend comprises:

(a) from 5 to 95 weight % of the polyester compositions of the present disclosure as described herein; and

(b) from 5 to 95 weight % of at least one polymeric component.

Suitable examples of the polymeric components include, but are not limited to, nylon; polyesters different than those described herein; polyamides such as ZYTEL® from DuPont; polystyrene; polystyrene copolymers; styrene acrylonitrile copolymers; acrylonitrile butadiene styrene copolymers; poly(methyl methacrylate); acrylic copolymers; poly(ether-imides) such as ULTEM® (a poly(ether-imide) from General Electric); polyphenylene oxides such as poly(2,6-dimethylphenylene oxide) or poly(phenylene oxide)/polystyrene blends such as NORYL 1000® (a blend of poly(2,6-dimethylphenylene oxide) and polystyrene resins from General Electric); polyphenylene sulfides; polyphenylene sulfide/sulfones; poly(ester-carbonates); polycarbonates such as LEXAN® (a polycarbonate from Sabic); polysulfones; polysulfone ethers; and poly(ether-ketones) of aromatic dihydroxy compounds; or mixtures of any of the foregoing polymers. In one embodiment, aliphatic-aromatic polyesters can be excluded from the polyester compositions useful in this disclosure. The following polyesters, which can be blended to make the polyester compositions of this disclosure, can be excluded as the polymeric components used in additional blending if such blending exceeds the compositional ranges of the invention: polyethylene terephthalate (PET), glycol modified PET (PETG), glycol modified poly(cyclohexylene dimethylene terephthalate) (PCTG), poly(cyclohexylene dimethylene terephthalate) (PCT), acid modified poly(cyclohexylene dimethylene terephthalate) (PCTA), poly(butylene terephthalate) and/or diethylene glycol modified PET (EASTOBOND™ copolyester).

The blends can be prepared by conventional processing techniques known in the art, such as melt blending or solution blending.

In embodiments, the polymer compositions, polyester compositions and the polymer blend compositions can also contain from 0.01 to 30% by weight of the overall composition additives such as colorants, toner(s), dyes, mold release agents, flame retardants, plasticizers, nucleating agents, stabilizers, including but not limited to, UV stabilizers, thermal stabilizers, and/or reaction products thereof, fillers, and impact modifiers. Examples of commercially available impact modifiers include, but are not limited to, ethylene/propylene terpolymers, functionalized polyolefins such as those containing methyl acrylate and/or glycidyl methacrylate, styrene-based block copolymeric impact modifiers, and various acrylic core/shell type impact modifiers. Residues of such additives are also contemplated as part of the polymer or polyester composition.

In addition, in some embodiments, the polymer or polyester composition may further comprise 0.1 to 10 weight percent of one or more of the following additives: antioxidants, melt strength enhancers, branching agents (e.g., glycerol, trimellitic acid and anhydride), chain extenders, flame retardants, fillers, opacifiers, acid scavengers, dyes, colorants, pigments, antiblocking agents, flow enhancers, impact modifiers, antistatic agents, processing aids, mold release additives, plasticizers, slips, stabilizers, waxes, UV absorbers, optical brighteners, lubricants, pinning additives, foaming agents, antistats, nucleators, glass beads, metal spheres, ceramic beads, carbon black, crosslinked polystyrene beads, and the like. Colorants, sometimes referred to as toners, may be added to impart a desired neutral hue and/or brightness to the polyester and the voided film. Optionally, in some embodiments, the polyester compositions may comprise 0 to 10 weight percent of one or more processing aids to alter the surface properties of the composition and/or to enhance flow. Representative examples of processing aids include calcium carbonate, talc, clay, mica, zeolites, wollastonite, kaolin, diatomaceous earth, TiO₂, NH₄Cl, silica, calcium oxide, sodium sulfate, and calcium phosphate.

Use of titanium dioxide and other pigments or dyes, might be included, for example, to control whiteness of the film or to make a colored film. For example, in one embodiment, TiO₂ is added in an amount of 0-50 wt %, 0-20 wt %, 0-10 wt %, or 0-5 wt %, or 0-3 wt %, or 1-4 wt % as an opacifier or to provide opacity to the film.

In one embodiment, an antistat or other coating may also be applied to one or both sides of the film. Corona and/or flame treatment is also an option to enhance printability although not typically necessary because of the high surface tension of the voided films. For certain combinations of polymers, it may also be necessary to add acid scavengers and stabilizers to prevent degradation/browning of any cellulose esters which may be present as voiding agents. In some embodiments, the presence of voids and any additives that may be used in the film also serve to block the transmission of UV light for applications with UV sensitive products.

Reinforcing materials may be added to the compositions useful in this disclosure. The reinforcing materials may include, but are not limited to, carbon filaments, silicates, mica, clay, talc, titanium dioxide, Wollastonite, glass flakes, glass beads and fibers, and polymeric fibers and combinations thereof. In one embodiment, the reinforcing materials include glass, such as, fibrous glass filaments, mixtures of glass and talc, glass and mica, and glass and polymeric fibers.

Generally, the shrinkable films according to the present disclosure may contain from 0.01 to 10 weight percent of the polyester plasticizer. In one embodiment, the shrinkable films can contain from 0.1 to 5 weight percent of the polyester plasticizer. Generally, the shrinkable films can contain from 90 to 99.99 weight percent of the copolyester. In certain embodiments, the shrinkable films can contain from 95 to 99.9 weight percent of the copolyester.

The polymeric films of the present disclosure can be used in a wide variety of applications. For example, in one embodiment, the films of the present disclosure are useful in applications, including, but not limited to, packaging, plastic bags, labels, shrinkable labels, building construction, landscaping, electrical fabrication, photographic film, film stock for films, and video tape. Any polymers or plastics that can be formed into a film is suitable for use in the present disclosure, including, but are not limited to including polyethylene, polypropylene, polycarbonate, polystyrene, polyesters, nylons, polyvinyl chloride (PVC), cellulose acetate, polyvinylidene chloride, cellophane, ethylene methylacrylate copolymer, poly(lactic acid), bioplastics, and biodegradable plastics. These polymers can be processed in a variety of ways to make the films of the present disclosure including processes such as film casting, extrusion, calendering, solution casting, skiving, coextrusion, lamination, and extrusion coating. Once formed, the films can be further modified by roll slitting, coating or printing, and physical vapor deposition to make metallized films. Films can also be subjected to corona treatment or plasma processing and can have release agents applied as needed. In some embodiments, the films can be thermoformed, stretched, compression molded, and laminated.

In one aspect, this disclosure relates to films comprising the polymer compositions and/or polyester compositions of this disclosure. In one aspect, the present disclosure relates to shrinkable film(s), extruded articles, thermoformed articles, and molded article(s) of this disclosure comprising the polymer compositions and/or polyester compositions useful in this disclosure. In certain embodiments, this disclosure relates to film(s) and/or sheets comprising the polyester compositions and/or polymer compositions of this disclosure. Methods of forming the polyesters and/or polymer into film(s) and/or sheet(s) are well known in the art. Examples of film(s) and/or sheet(s) useful the present disclosure include, but not are limited to, extruded film(s) and/or sheet(s), compression molded film(s), calendered film(s) and/or sheet(s), solution casted film(s) and/or sheet(s). In one aspect, methods of making film and/or sheet useful to produce the shrinkable films of the present disclosure include but are not limited to extrusion, compression molding, calendering, and solution casting. Methods of making film and/or sheet include but are not limited to extrusion, calendering, compression molding, and solution casting, and in some embodiments, followed by stretching/orientation using typical methods such as tentering. In one aspect, this disclosure relates to calendered film(s) and/or sheets comprising the polyester compositions and/or polymer compositions of this disclosure.

The shrinkable films of the present disclosure can have an onset of shrinkage temperature of from 55 to 80° C., or 55 to 75° C., or 55 to 70° C. Shrink initiation temperature is the temperature at which the onset of shrinking occurs.

In certain embodiments, the polyester compositions useful in the present disclosure can have densities of 1.6 g/cc or less, or 1.5 g/cc or less, or 1.4 g/cc or less, or 1.1 g/cc to 1.5 g/cc, or 1.2 g/cc to 1.4 g/cc, or 1.2 g/cc to 1.35 g/cc.

In one embodiment, after the addition of the hollow glass microspheres, the density of the compounded product is 1.3 g/cc or less, or 1.0 g/cc or less, or 0.96 g/cc or less, or 0.80 g/cc or less, or 0.75 g/cc or less, or 0.65 g/cc or less, or to 1.0 g/cc to 0.50 g/cc, or 0.96 g/cc to 0.60 g/cc, or 0.75 g/cc to 0.65 g/cc.

In one embodiment, the approach for reducing the density is to introduce many small, low density voids or holes into the film using a voiding agent. This process is called “voiding” and may also be referred to as “cavitating” or “microvoiding”. In one embodiment, the voids are obtained by incorporating 1 to 50 weight % of small, low density organic or inorganic hollow bubbles or spheres, as the voiding agent, into a matrix polymer and orienting the polymer by stretching in at least one direction. In the present disclosure, voids are created because the microspheres are hollow. During stretching, additional small cavities or voids are formed around the hollow microspheres. This dual voiding creates a larger number of voids. Additionally, the voids created by the hollow microspheres are stable so they are maintained after shrinkage, and this enables the stretched films to maintain a lower density after shrinkage occurs. In some embodiments, when the voids are introduced into the polymer films, the resulting voided films not only has a lower density than the non-voided films, but they also become opaque.

In certain embodiments, the as extruded films are oriented while they are stretched. The oriented films or shrinkable films of the present disclosure can be made from films having any thickness depending on the desired end-use. The desirable conditions are, in one embodiment, where the oriented films and/or shrinkable films can be printed with ink for applications including labels, photo films which can be adhered to substrates such as paper, and/or other applications that it may be useful in. In some embodiments, it may be desirable to coextrude or laminate the polyesters useful in the present disclosure with another polymer, such as PET or polypropylene, to make the films useful in making the oriented films and/or shrinkable films of this disclosure. One advantage of doing the latter is that a tie layer may not be needed in some embodiments.

In one embodiment, the as-extruded films have a thickness of 100 microns to 1000 um, or from 250 to 500 microns, or from 100 to 500 microns, or from 250 um to 1000 um. In one embodiment, the as-extruded sheets have a thickness of 1001 to 50,800 microns, or from 1001 to 25,400 microns, or from 1001 to 12,700 microns, or from 1001 to 6300 microns.

In one embodiment, the as-extruded films can be monoaxially or biaxially stretched/oriented to form shrinkable films of the present disclosure. The shrinkable films of the present invention can be made from as-extruded films having a thickness of 100 to 400 microns, for example, extruded, cast or calendered films, which can then be stretched at a ratio of 8:1 to 2:1 at a temperature of from the Tg of the film to the Tg+55° C., and which can be stretched to a thickness of 15 to 133 microns. In one embodiment, the orientation of the initial as-extruded film can be performed on a tenter frame according to these orientation conditions. The shrinkable films of the present disclosure can be made from the oriented films of this disclosure.

In certain embodiments, the shrinkable films of the present disclosure have gradual shrinkage with little to no wrinkling. In certain embodiments, the shrinkable films of the present disclosure have no more than 40% shrinkage in the transverse direction per 5° C. temperature increase increment.

In certain embodiments of the present disclosure, the shrinkable films of this disclosure have shrinkage in the machine direction of from 4% or less, or 3% or less, or 2.5% or less, or 2% or less, or no shrinkage when immersed in water at 65° C. for 10 seconds. In certain embodiments of the present disclosure, the shrinkable films of this disclosure have shrinkage in the machine direction of from −5% to 4%, −5% to 3%, or −5% to 2.5%, or −5% to 2%, or −4% to 4%, or −3% to 4% or −2% to 4%, or −2% to 2.5%, or −2% to 2%, or 0 to 2%, or no shrinkage, when immersed in water at 65° C. for 10 seconds. Negative machine direction shrinkage percentages here indicate machine direction growth. Positive machine direction shrinkages indicate shrinkage in the machine direction.

In certain embodiments of the present disclosure, the shrinkable films of this disclosure have shrinkage in the main shrinkage direction of from 50% or greater, or 60% or greater, or 70% or greater, when immersed in water at 95° C. for 10 seconds.

In certain embodiments of the present disclosure, the shrinkable films of this disclosure have shrinkage in the main shrinkage direction in the amount of 50 to 90% and shrinkage in the machine direction of 4% or less, or from −5% to 4%, when immersed in water at 95° C. for 10 seconds.

In one embodiment, the polyesters useful in the present disclosure are made into films using any method known in the art to produce films from polymers or polyesters, for example, solution casting, extrusion, compression molding, or calendering. The as extruded (or as formed) film is then oriented in one or more directions (e.g., monoaxially and/or biaxially oriented film). This orientation of the films can be performed by any method known in the art using standard orientation conditions. For example, the monoaxially oriented films of the present disclosure can be made from films having a thickness of 100 to 400 microns, such as, extruded, cast or calendered films, which can be stretched at a ratio of 8:1 to 2:1 at a temperature of from the Tg of the film to the Tg+55° C., and which can be stretched to a thickness of 10 to 150 microns. In one embodiment, the orientation of the initial as extruded film can be performed on a tenter frame according to these orientation conditions.

In certain embodiments of the present disclosure, the shrinkable films of this disclosure have no more than 40% shrinkage in the transverse direction per 5° C. temperature increase increment.

In certain embodiments of the present disclosure, the shrinkable films of this disclosure can have an onset of shrinkage temperature of from 55 to 80° C., or 55 to 75° C., or 55 to 70° C. Onset of shrinkage temperature is the temperature at which onset of shrinking occurs.

In certain embodiments of the present disclosure, the shrinkable films of this disclosure can have an onset of shrinkage temperature of between 55° C. and 70° C.

In certain embodiments of the present disclosure, the shrinkable films of this disclosure can have a tensile stress at break (break stress) of from 1 to 400 MPa; or 1 to 260 MPa; or 1 to 100 MPa; or 1 to 50 MPa; or 1 to 20 MPa; or 1 to 10 MPa; or 1 to 5 MPa; or 5 to 10 MPa as measured according to ASTM Method D882.

In certain embodiments of the present disclosure, the shrinkable films of this disclosure can have a shrink force of from 1 to 10 MPa, or from 1 to 5 MPa, as measured by ISO Method 14616 using a Shrink Force Tester made by LabThink @ 80° C. depending on the stretching conditions and the end-use application desired.

In one embodiment of the present disclosure, the polyester compositions can be formed by reacting the monomers by known methods for making polyesters in what is typically referred to as reactor grade compositions.

In one embodiment of the present disclosure, the polyester compositions of this disclosure can be formed by blending polyesters, such as polyethylene terephthalate (PET), glycol modified PET (PETG), glycol modified poly(cyclohexylene dimethylene terephthalate) (PCTG), poly(cyclohexylene dimethylene terephthalate) (PCT), acid modified poly(cyclohexylene dimethylene terephthalate) (PCTA), poly(butylene terephthalate) and/or diethylene glycol modified PET to achieve the monomer ranges of these compositions.

Reinforcing materials can be added to the polyester compositions useful in this disclosure. The reinforcing materials may include, but are not limited to, carbon filaments, silicates, mica, clay, talc, titanium dioxide, Wollastonite, glass flakes, glass beads and fibers, and polymeric fibers and combinations thereof. In one embodiment, the reinforcing materials include glass, such as, fibrous glass filaments, mixtures of glass and talc, glass and mica, and glass and polymeric fibers.

Molded articles can also be manufactured from any of the polyester compositions disclosed herein and are included within the scope of the present disclosure.

Generally, the shrinkable films according to the present disclosure may contain from 0.01 to 10 weight percent of the polyester plasticizer. In one embodiment, the shrinkable films can contain from 0.1 to 5 weight percent of the polyester plasticizer. Generally, the shrinkable films can contain from 90 to 99.99 weight percent of the copolyester. In certain embodiments, the shrinkable films can contain from 95 to 99.9 weight percent of the copolyester.

The shape of the films useful in making the oriented films or shrinkable films of the present disclosure is not restricted in any way. For example, it may be a flat film or a film that has been formed into a tube. In order to produce the shrinkable films useful in the present disclosure, the polyester is first formed into a flat film and then is “uniaxially stretched”, meaning the polyester film is oriented in one direction. The films could also be “biaxially oriented,” meaning the polyester films are oriented in two different directions; for example, the films are stretched in both the machine direction and a direction different from the machine direction. Typically, but not always, the two directions are substantially perpendicular. For example, in one embodiment, the two directions are in the longitudinal or machine direction (“MD”) of the film (the direction in which the film is produced on a film-making machine) and the transverse direction (“TD”) of the film (the direction perpendicular to the MD of the film). Biaxially oriented films may be sequentially oriented, simultaneously oriented, or oriented by some combination of simultaneous and sequential stretching.

The films may be oriented by any usual method, such as the roll stretching method, the long-gap stretching method, the tenter-stretching method, and the tubular stretching method. With use of any of these methods, it is possible to conduct biaxial stretching in succession, simultaneous biaxial stretching, uni-axial stretching, or a combination of these. With the biaxial stretching mentioned above, stretching in the machine direction and transverse direction may be done at the same time. Also, the stretching may be done first in one direction and then in the other direction to result in effective biaxial stretching. In one embodiment, stretching of the films is done by preliminarily heating the films 5° C. to 80° C. above their glass transition temperature (Tg).

In one embodiment, the films can be preliminarily heated from 10° C. to 30° C. above their Tg. In one embodiment, the stretch rate is from 1 to 20 inches (2.54 to 50.8 cm) per second. Next, the films can be oriented, for example, in either the machine direction, the transverse direction, or both directions from 2 to 8 times the original measurements. In one embodiment, the films can be oriented as a single film layer or can be coextruded or laminated with other polymer or polyesters such as PET (polyethylene terephthalate) or a polyolefin such as polypropylene as a multilayer film which can contain 2 or a plurality of layers and then oriented.

In one embodiment, the present disclosure includes an article of manufacture or a shaped article comprising the films or sheet of any of the embodiments of this disclosure. In another embodiment, the present disclosure includes an article of manufacture or a shaped article comprising the films of any of the embodiments of this disclosure.

In certain embodiments, the present disclosure includes but is not limited to shrinkable films applied to containers, plastic bottles, glass bottles, packaging, batteries, hot fill containers, and/or industrial articles or other applications. In one embodiment, the present disclosure includes but is not limited to oriented films applied to containers, packaging, plastic bottles, glass bottles, photo substrates such as paper, batteries, hot fill containers, and/or industrial articles or other applications.

In certain embodiments of the present disclosure, the shrinkable films of this disclosure can be formed into a label or sleeve. The label or sleeve can then be applied to an article of manufacture, such as, the wall of a container, battery, or onto a sheet or film.

The oriented films or shrinkable films of the present disclosure can be applied to shaped articles, such as, sheets, films, tubes, bottles and are commonly used in various packaging applications. For example, films and sheets produced from polymers such as acrylic polymers, polyolefins, polystyrene, poly(vinyl chloride), polyesters, polylactic acid (PLA) and the like are used frequently for the manufacture of shrinkable labels for plastic beverage or food containers. For example, the shrinkable films of the present disclosure can be used in many packaging applications where the shaped article exhibits properties, such as, good printability, high opacity, higher shrink force, good texture, and good stiffness.

The combination of the improved shrink properties as well as the improved density and transmittance should offer new commercial options, including but not limited to, recyclability for shrinkable films applied to containers, plastic bottles, glass bottles, packaging, batteries, hot fill containers, and/or industrial articles or other applications.

### Hollow Microspheres

The films of the present disclosure include a voiding agent dispersed therein that comprises hollow microspheres or bubbles. One embodiment of the present disclosure are films that include a voiding agent dispersed therein that comprises hollow glass microspheres or bubbles. One embodiment is a film comprising: (1) at least one polymer and (2) hollow microspheres. Another embodiment is a shrinkable film comprising: (1) at least one polymer and (2) hollow microspheres. Another embodiment is a multilayer film comprising: at least one layer (layer A) comprising (1) at least one polymer and (2) hollow microspheres, and at least one layer (layer B) comprising at least one polymer.

Another embodiment is a film laminate comprising: at least one layer (layer A) comprising (1) at least one polymer and (2) hollow microspheres, at least one layer (layer B) comprising at least one polymer and optionally a laminating adhesive.

One embodiment of the present disclosure is a voided film comprising (1) 80-98 wt % of at least one polymer selected from acrylic polymers, polyolefins, cellulose esters, cellulose acetate, cellulose triacetate, cellulose propionate, cellulose butyrate, cellulose acetate propionate, cellulose acetate butyrate, cellulose propionate butyrate, cyclic olefin copolymers, ethylene methyl acrylate copolymer, polycarbonate, polypropylene, polystyrene, polystyrene butadiene copolymers or blends, polyethylene, ethylene/propylene copolymer, ethylene-vinyl acetate (EVA), ethylene vinyl alcohol copolymer, polyvinyl chloride, poly(lactic acid), polyvinylidene chloride, nylon, polyethylene terephthalate (PET), polyesters, copolyesters, and mixtures thereof; and (2) 2-20 wt % of hollow glass microspheres.

One embodiment of the present disclosure is a voided film comprising (1) 85-95 wt % of at least one polymer selected from acrylic polymers, polyolefins, cellulose esters, cellulose acetate, cellulose triacetate, cellulose propionate, cellulose butyrate, cellulose acetate propionate, cellulose acetate butyrate, cellulose propionate butyrate, cyclic olefin copolymers, ethylene methyl acrylate copolymer, polycarbonate, polypropylene, polystyrene, polystyrene butadiene copolymers or blends, polyethylene, ethylene/propylene copolymer, ethylene-vinyl acetate (EVA), ethylene vinyl alcohol copolymer, polyvinyl chloride, poly(lactic acid), polyvinylidene chloride, nylon, polyethylene terephthalate (PET), polyesters, copolyesters, and mixtures thereof; and (2) 5-15 wt % of hollow glass microspheres.

In one embodiment, the voiding agents dispersed in the shrinkable films comprise low density, hollow glass microspheres or glass bubbles. The hollow microspheres of the present disclosure are also known as spheres, balls, bubbles or micro-balloons. The hollow microspheres of the present disclosure are distinct from solid microbeads or solid beads in that solid beads or microbeads are filled, and they are not hollow as required in the present disclosure.

In one embodiment, hollow glass microspheres or glass bubbles may be included in the polymer compositions or in the films in any amount to obtain the desired properties. For example, in one embodiment, the hollow glass microspheres are included in an amount of 0.1 to 60 wt %, or from 0.5 to 50 wt %, or from 1 to 50 wt %, or from 1 to 30 wt %, or from 1 to 20 wt %, or from 1 to 15 wt %, or from 1-10 wt %, or from 2 to 20 wt %, or from 10 to 20 wt %, or from 10 to 15 wt % or from 15 to 20 wt %, or from 5 to 20 wt %, or from 5 to 10 wt %, or from 5 to 30 wt %. In one embodiment, the hollow glass microspheres are included in an amount of 8 to 18 wt %. In one embodiment, the hollow glass microspheres are included in an amount of 10 wt % or greater. In one embodiment, the hollow glass microspheres are included in an amount of 5 wt % or greater.

In the present disclosure, suitable hollow glass microspheres are spherical microparticles typically ranging from 1 micron to 1000 microns in diameter. In one embodiment, the hollow glass microspheres have a particle size (D50 Micron or microns by volume) from 1 to 500 um, or from 2 to 200 um or from 5 to 180 um, or from 15 to 135 um. In one embodiment, the hollow glass microspheres have a particle size of 1 to 100 um, or 5 to 100 um, 5 to 90 um, or 9 to 80 um, or 9 to 30 um, or 10 to 50 um, or 12 to 40 um, or 12 to 30 um, 13 to 35 um, 15 to 30 um, 15 to 35 um, or 20 to 30 um or 20 to 40 um.

In one embodiment, the glass microspheres of the present disclosure are hollow and comprise soda-lime-borosilicate glass. These hollow glass microspheres are low in density and lightweight, but they have a high crush strength, which allows them to be processed through extruders and mixers without breaking to produce shrinkable films that have a significantly reduced density. The hollow glass microspheres in the present disclosure have a high strength to density ratio. Hollow glass microspheres have a low density, but they have the strength required to undergo processing while remaining intact with only a small percentage of the microspheres being crushed during processing.

In one embodiment, the hollow glass microspheres have a crush strength of at least 500 psi or greater, or of at least 1,000 psi or greater, or of at least 5,000 psi or greater, or of at least 6,000 psi or greater, or of at least 7,000 psi or greater, or of at least 10,000 psi or greater, or of at least 15,000 psi or greater, or of at least 16,500 psi or greater. In one embodiment, the hollow glass microspheres have a crush strength from 250 psi to 30,000 psi. In one embodiment, the hollow glass microspheres have a crush strength from 1000 psi to 30,000 psi. In one embodiment, the hollow glass microspheres have a crush strength from 5000 psi to 30,000 psi. In one embodiment, the glass microspheres have a crush strength from 10,000 psi to 30,000 psi. In another embodiment, the hollow glass microspheres have a crush strength from 15,000 psi to 28,000 psi. In yet another embodiment, the hollow glass microspheres have a crush strength from 16,000 psi to 20,000 psi.

The low density, hollow glass microspheres in the present disclosure are chemically stable, noncombustible, nonporous, and have excellent water resistance.

In one embodiment, the hollow glass microspheres suitable for use in the present disclosure have a density from 0.06 to 1.4 g/cc, or from 0.44 g/cc to 0.83 g/cc or from 0.10 to 0.60 g/cc. In one embodiment, the glass microspheres have a density from 0.20 to 0.80 g/cc, from 0.30 to 0.60 g/cc, or 0.15 to 0.60 g/cc, or 0.4 to 0.5 g/cc, or 0.2 to 0.6 g/cc, or 0.15 to 0.6 g/cc. In another embodiment, the glass microspheres have a density from 0.4 to 0.60 g/cc; from 0.46 to 0.6 g/cc; or from 0.45 to 0.6 g/cc.

In one embodiment, the hollow glass microspheres have a density from 0.15 to 0.6 g/cc; a particle size from 5 to 180 μm; and a crush strength of at least 250 psi. In one embodiment, the hollow glass microspheres have a density from 0.4 to 0.6 g/cc; a particle size from 10 to 35 μm; and a crush strength from 16,000 to 20,000 psi. In one embodiment, the hollow glass microspheres have a density of 0.46 g/cc; a particle size of less than 35 μm; and a crush strength from 16,000 psi.

In one embodiment, the hollow glass microspheres comprise 0.5-60 wt % of the shrinkable film or at least one layer of the multilayer film. In one embodiment, the hollow glass microspheres comprise 1.0-50 wt % of the shrinkable film or at least one layer of the multilayer film. In one embodiment, the hollow glass microspheres comprise 5-30 wt %; or 5-20 wt %; 5-10 wt %; or 10-30 wt %; or 10-20 wt %; or 20-30 wt % of the shrinkable film or at least one layer of the multilayer film.

### Additional Voiding Agents

In one embodiment of the present disclosure, the films may further comprise additional voiding agents dispersed therein. In one embodiment, suitable additional voiding agents include at least one polymer selected from acrylic polymers, cellulosic polymers, starch, esterified starch, polyketones, polyester, polyamides, polysulfones, polyimides, polycarbonates, olefinic polymers, and copolymers thereof. The term “olefinic polymer”, as used herein is intended to mean a polymer resulting from the addition polymerization of ethylenically unsaturated monomers such as, for example, polyethylene, polypropylene, polystyrene, poly(acrylonitrile), poly(acrylamide), acrylic polymers, poly(vinyl acetate), poly(vinyl chloride), and copolymers of these polymers. The additional voiding agent may also comprise one or more inorganic compounds such as, for example talc, silicon dioxide, titanium dioxide, calcium carbonate, barium sulfate, kaolin, wollastonite, and mica. The additional voiding agent also may comprise a combination of polymeric and inorganic materials.

### Plasticizers

In some embodiments of the present disclosure, the polymer composition further comprises at least one plasticizer. In one embodiment, the plasticizer comprises a polyester plasticizer. In one embodiment, the polyester plasticizers have a weight-average molecular weight (Mw) of 900 to 12,000 g/mol. For example, in one embodiment, the plasticizer has a Mw of 1,000 to 5,000 g/mol.

In one embodiment, the polyester plasticizers comprise (i) a polyol component comprising the residues of a polyol having 2 to 8 carbon atoms, and (ii) a diacid component comprising the residues of a dicarboxylic acid having 4 to 12 carbon atoms.

Suitable polyols containing from 2 to 8 carbons atoms include ethylene glycol, 1,2- or 1,3-propanediol; 1,2- or 1,3- or 1,4-butanediol; diethylene glycol; and dipropylene glycol.

Suitable dicarboxylic acids may be represented by the formula HO(O)CRC(O)OH where R is selected from the group consisting of linear and branched alkylene radicals containing from 2 to 10 carbon atoms and phenylene. Specific examples of such dicarboxylic acids include succinic acid, glutaric aid, adipic acid, azelaic acid, sebacic acid, isophthalic acid, orthophthalic acid, terephthalic acid, benzene-1,2-dicarboxylic acid, benzene-1,4-dicarboxylic acid, and mixtures thereof. Anhydrides of these diacids can also be used.

In one embodiment, the polyester plasticizer comprises residues of phthalic acid, adipic acid, or mixtures thereof; and residues of 1,2-propanediol, 1,3-butanediol, 1,4-butanediol, or mixtures thereof.

The plasticizers according to the present disclosure can, in general, be made by reacting one or more diols, glycols, and/or polyols with one or more cyclic or aliphatic organic acids containing two or more acid functionalities until the desired molecular weight is obtained as determined by viscosity measurements or any other generally acceptable method. The molecular weight of the polymer can be controlled by capping the unreacted acid or alcohol functionality at the end of the polyester chains using either mono-functional alcohols or monobasic carboxylic acids until the desired hydroxyl and/or acid number of the product is reached. The hydroxyl numbers of the polyester plasticizers can range from 0 to 40 mg KOH/g, and the acid numbers or acid values can range from 0 to 50 mg KOH/g; for example, from 1 to 5 mg KOH/g.

The capping agents can be chosen from any number of readily available alcohols or acids. Suitable capping alcohols can contain 2 to 18 carbon atoms and can be linear or branched. Suitable monobasic acid capping agents include those containing 2 to 22 carbons and can be any number of fatty acids containing C8 to C22 carbons or other common acids such as acetic acid or 2-ethyl hexanoic acid. Anhydrides, such as acetic anhydride, can be used in place of the acid.

An example of polyester plasticizers suitable for use in the present disclosure are available commercially under the name Admex™ from Eastman Chemical Company.

In one embodiment, the film, the shrinkable film or at least one layer of the multilayer film or laminate comprises

(1) 70-99 wt % at least one polymer which comprises a polymer composition comprising:
(a) 40-99 wt % of at least one cellulose ester;
(b) 1-30 wt % of a plasticizer;
(c) 0-10 wt % ethylene methyl acrylate copolymer
(d) 0-20 wt % of an impact modifier; and

(2) 1-30 wt % of hollow glass microspheres.

In another embodiment, the film, the shrinkable film or at least one layer of the multilayer film or laminate comprises

(1) 70-99 wt % at least one polymer which comprises a polymer composition comprising:
(a) 40-99 wt % of at least one cellulose ester;
(b) 0-30 wt % of a plasticizer;
(c) 0-10 wt % ethylene methyl acrylate copolymer
(d) 1-20 wt % of an impact modifier; and

(2) 1-30 wt % of hollow glass microspheres.

In one embodiment, the cellulose ester is chosen from cellulose acetate, cellulose triacetate, cellulose propionate, cellulose butyrate, cellulose acetate propionate, cellulose acetate butyrate, cellulose propionate butyrate, cellulose tripropionate (CTP), cellulose tributyrate (CTB), or mixtures thereof. In one embodiment, the cellulose ester is chosen from cellulose acetate, cellulose triacetate, cellulose propionate, cellulose butyrate, cellulose acetate propionate, cellulose acetate butyrate, or mixtures thereof. In one embodiment, the cellulose ester is chosen from cellulose acetate, cellulose triacetate, cellulose acetate propionate, cellulose acetate butyrate, and mixtures thereof.

In some embodiments, when the polymer compositions comprise cellulose esters, then any plasticizers suitable for use in cellulose ester compositions may be used. For example, in one embodiment suitable plasticizers comprise one or more of the following phthalates, isophthalates, fatty acid esters (i.e., oleates, adipates, fumarates, sebecates, maleates, succinates), polyalcohol ethers or esters (i.e., esters of glycerol, esters or ethers of polyethylene glycol), benzoates, diethylene glycol dibenzoate, azelates, arylene-bis(diaryl phosphate), citrates, phosphates, polyesters, trimellitates (i.e., trimellitic acid tributyl ester, trioctyl trimellitate), and the like.

In one embodiment, the plasticizer is at least one plasticizer selected from triacetin, trimethyl phosphate, triethyl phosphate, tributyl phosphate, triphenyl phosphate, triethyl citrate, acetyl trimethyl citrate, acetyl triethyl citrate, acetyl tributyl citrate, tributyl-o-acetyl citrate, dibutyl phthalate, diaryl phthalate, diethyl phthalate, dimethyl phthalate, di-2-methoxyethyl phthalate, di-octyl phthalate, di-octyl adipate, dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, ethylene glycol, diethylene glycol, 1,2-propylene glycol, 1,3-propylene glycol, 1,2-butylene glycol, 1,3-butylene glycol, 1,4-butylene glycol, neopentyl glycol, 1,5-pentanediol, 1,6 hexanediol, 1,5-pentylene glycol, triethylene glycol, and tetraethylene glycol, aromatic diol, substituted aromatic diols, aromatic ethers, tripropionin, tribenzoin, polycaprolactone, glycerin, glycerin esters, diacetin, propylene glycol dibenzoate, glyceryl tribenzoate, diethylene glycol dibenzoate, triethylene glycol dibenzoate, di propylene glycol dibenzoate, and polyethylene glycol dibenzoate, glycerol acetate benzoate, stearyl alcohol, lauryl alcohol, phenol, benzyl alcohol, hydroquinone, catechol, resorcinol, ethylene glycol, neopentyl glycol, 1,4-cyclohexanedimethanol, diethylene glycol, polyethylene glycol, polyethylene glycol esters, polyethylene glycol diesters, di-2-ethylhexyl polyethylene glycol ester, triethylene glycol bis-2-ethyl hexanoate, glycerol esters, diethylene glycol, polypropylene glycol, polyglycoldiglycidyl ethers, dimethyl sulfoxide, N-methyl pyrollidinone, C1-C20 dicarboxylic acid esters, dimethyl adipate, di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, γ-valerolactone, alkylphosphate esters, aryl phosphate esters, phospholipids, eugenol, cinnamyl alcohol, camphor, methoxy hydroxy acetophenone, vanillin, ethylvanillin, 2-phenoxyethanol, glycol ethers, glycol esters, glycol ester ethers, polyglycol ethers, polyglycol esters, ethylene glycol ethers, propylene glycol ethers, ethylene glycol esters, propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, diethylene glycol dibenzoate, dipropylene glycol dibenozoate, triethylene glycol dibenzoate, butylated hydroxytoluene, butylated hydroxyanisol, sorbitol, xylitol, ethylene diamine, piperidine, piperazine, hexamethylene diamine, triazine, triazole, pyrrole, and mixtures thereof.

In one embodiment, the impact modifier is at least one impact modifier selected from modified polyolefins; block copolymers; acrylics; thermoplastic elastomers including styrenic materials such as SBS, SEBS, and SIS; polyester-ether copolymers; polyamide-ether copolymers; core-shell impact modifiers; MBS core-shell impact modifiers such as a methacrylate-butadiene-styrene that has a core made out of butadiene-styrene copolymers and shell made out of methyl methacrylate-styrene copolymer; acrylic core-shell impact modifiers that has a core made from an acrylic polymer, such as butyl acrylate or styrene butyl acrylate, and shell from made from polymethylmethacrylate or styrene methylmethacryalate copolymer; and mixtures thereof. In one embodiment, the impact modifiers include, but are not limited to, ethylene/propylene terpolymers, functionalized polyolefins such as those containing methyl acrylate and/or glycidyl methacrylate, styrene-based block copolymeric impact modifiers, and various acrylic core/shell type impact modifiers.

### Process of Making the Films and Shrinkable Films

The present disclosure includes a process for making a void-containing film. The present disclosure further includes a process for making a void-containing shrinkable film having a shrinkage of at least 40% after 10 seconds in water bath at 95° C. and a density of less than 1.0 g/cc, comprising: (i) mixing at least one polyester and 1 to 50 wt % of a voiding agent at a temperature at or above the Tg of said polyester to form a uniform dispersion of the voiding agent within the polyester; (ii) forming a film; (iii) orienting the film of step (ii) in one or more directions; and optionally (iv) annealing the film from step (iii) at a temperature of about Tg to Tg plus 40° C.

The void-containing films of the present disclosure have high shrinkage and maintain their low density after exposure to temperatures typically present during recycling processes. The films may be used as roll-fed or traditional shrink-sleeve labels, can be printed easily, and seamed by traditional means. The void-containing, polyester shrinkable film may be separated from mixtures of polymers and, thus, may be easily recovered and recycled from commercial waste by separation in water. The recyclability of our shrinkable film in combination with its excellent physical properties make it particularly useful for labels and in other packaging applications.

The shrinkable film of the disclosure comprises an oriented polyester. The term “oriented”, as used herein, means that the polyester is stretched to impart direction or orientation in the polymer chains. The polyester, thus, may be “uniaxially stretched”, meaning the polyester is stretched in one direction or “biaxially stretched,” meaning the polyester has been stretched in two different directions. In some embodiments, the two directions are substantially perpendicular. For example, in the case of a film, the two directions are in the longitudinal or machine direction (“MD”) of the film (the direction in which the film is produced on a film-making machine) and the transverse direction (“TD”) of the film (the direction perpendicular to the MD of the film). Biaxially stretched films may be sequentially stretched, simultaneously stretched, or stretched by some combination of simultaneous and sequential stretching.

The films may be stretched in one or more directions and may comprise one or more layers.

The shrinkable film of the instant disclosure may comprise a single layer or contain a plurality of layers in which at least one layer comprises a voiding agent. The disclosure, therefore, is understood to include films in which the single layered film may be incorporated as one or more layers of a multilayered structure such as, for example, a laminate or a coextrusion such as, for example, in roll-fed labels where the printed label is adhered or laminated to the void-containing substrate.

Sleeves and labels may be prepared from the void-containing films, shrinkable films, multilayer films, multilayer shrinkable films and laminate films of the present disclosure according to methods well known in the art. These sleeves and labels are useful for packaging applications such as, for example, labels for plastic bottles comprising poly(ethylene terephthalate).

One embodiment, provides a sleeve or roll-fed label comprising the void-containing shrinkable films described hereinabove. These sleeves and labels may be conveniently seamed by methods well-known in the art such as, for example, by solvent bonding, adhesive bonding, pressure sensitive adhesive bonding, hot-melt glue bonding, UV-curable adhesive bonding, radio frequency sealing, heat sealing, ultrasonic bonding, air curable adhesive bonding, or dry liquid adhesive bonding. For traditional shrink sleeves involving transverse oriented film (via tentering or double bubble), the label is first printed and then seamed along one edge to make a tube. Solvent seaming can be performed using any of a number of solvents or solvent combinations known in the art such as, for example, THF, dioxylane, acetone, cyclohexanone, methylene chloride, n-methylpyrrilidone, and MEK. These solvents have solubility parameters close to that of the film and serve to dissolve the film surface sufficiently for welding. Other methods such as RF sealing, adhesive gluing, UV curable adhesive bonding, and ultrasonic bonding can also be used. The resulting seamed tube is then cut and applied over the bottle prior to shrinking in a steam, infrared or hot air type tunnel. During the application of the sleeve with certain types of sleeving equipment, it is important that the film have enough stiffness to pass over the bottle without crushing or collapsing as the sleeve tends to stick to or “grab” against the side of the bottle because of friction. The void-containing sleeves of the present disclosure have a coefficient of friction (COF) that typically is about 20 to 30% lower than that of the non-voided film. This lower COF helps to prevent label hanging and make sleeve application easier and is an unexpected benefit of the present disclosure.

For roll-fed labels, the void-containing film is traditionally oriented in the machine direction using, for example, a drafter. These labels are wrapped around the bottle and typically glued in place in-line. As production line speeds increase, however, faster seaming methods are needed, and UV curable, RF sealable, and hot melt adhesives are becoming more preferred over solvent seaming. For example, in one embodiment, a hot melt polyester might be useful to seam a polyester-based void-containing film.

The void-containing film or sheet may be prepared by any methods well known to persons skilled in the art. In one embodiment, the void-containing film may be prepared by mixing the polyester with the voiding agents, forming a film, orienting the film by stretching in one or more directions, and optionally annealing the oriented film. In some embodiments, the shrinkable films are annealed. In some embodiment, the shrinkable films are not annealed. Thus, another aspect of our disclosure is a process for a void containing shrinkable film having a shrinkage of at least 20% after 10 seconds in water bath at 95° C. and a density less than 1.0 g/cc, comprising: (i) mixing at least one polyester and 1 to 50 wt % of a voiding agent at a temperature at or above the Tg of said polyester to form a uniform dispersion of said voiding agent within said polyester; (ii) forming a film; (iii) orienting the film of step (ii) in one or more directions; and optionally (iv) annealing the film from step (iii) at a temperature of about Tg to Tg plus 40° C. Our inventive process includes all of the embodiments of the film, polyester, diacids, diols, modifying diacids, voiding agents, additives, and processing conditions described hereinabove. For example, in one embodiment, shrinkable film has a shrinkage of at least 20% after 10 seconds in water bath at 95° C. In another embodiment, the shrinkable film has a shrinkage of at least 60% after 10 seconds at 95° C. In yet another embodiment, the shrinkable film has a density of less than 1.00 g/cc. In one embodiment, the voiding agent comprises hollow microspheres. In another embodiment, the voiding agent comprises hollow glass microspheres.

The voiding agent is mixed and dispersed within the polymer or polyester matrix by methods well known to persons skilled in the art. The voiding agent and the polymer or polyester may be dry blended or melt mixed at a temperature at or above the Tg of the polyester in a single or twin-screw extruder, roll mill, or in a Banbury Mixer to form a uniform dispersion of the voiding agent in the polyester. For example, the mixture may be formed by forming a melt of the polyester and mixing therein the voiding agent. The hollow microsphere voiding agents may be in a solid form. Other voiding agents may be in a solid, semi-solid, or molten form. It is advantageous that the voiding agent is a solid to allow for rapid and uniform dispersion within the polyester upon mixing. The components of the voiding agent can be compounded together on a mixing device such as, for example, a twin-screw extruder, planetary mixer, or Banbury mixer, or the components can be added separately during film formation. When the voiding agent is uniformly dispersed in the polymer or polyester, the formation of the sheet or film may be carried out by methods well-known to persons skilled in the art such as, for example, extrusion, calendering, casting, drafting, tentering, or blowing. These methods initially create a non-oriented or “cast” film. In one embodiment, the non-oriented or “cast” films are subsequently stretched in at least one direction. In one embodiment, the non-oriented or “cast” films are subsequently stretched in at least one direction to impart orientation. Methods of unilaterally or bilaterally orienting sheet or film are well known in the art. Such sheet or film may also be stretched in the transverse or cross-machine direction by apparatus and methods well known in the art. In generally, stretch ratios of about 2× to about 8× are imparted in one or more directions to create uniaxially or biaxially oriented films. More typically, stretch ratios are from 2× to about 8×. The stretching can be performed, for example, using a double-bubble blown film tower, a tenter frame, or a machine direction drafter. Stretching is preferably performed at or near the glass transition temperature (Tg) of the polymer. For polyesters, for example, this range is typically Tg+5° C. (Tg+10° F.) to about Tg+33° C. (Tg+60° F.), although the range may vary slightly depending on additives. A lower stretch temperature will impart more orientation and voiding with less relaxation (and hence more shrinkage), but it may increase film tearing. To balance these effects, an optimum temperature in the mid-range is often chosen. Typically, a stretch ratio of 4.5× to 5.5× may be used to optimize the shrinkage performance and improve gauge uniformity.

The stretching processes may be done in line or in subsequent operations. Subsequently, the void-containing film may be printed and used, for example, as labels on beverage or food containers. Because of the presence of voids, the density of the film is reduced. Accordingly, the film will readily accept most printing inks and, hence, may be considered printable. The films of the present disclosure also may be used as part of a multilayer or coextruded film, or as a component of a laminated film or article. In one embodiment, a multilayer film may include a printable layer on the surface or as the outermost layer. In one embodiment the printable layer can have a glossy surface and in one embodiment the printable layer can have a low gloss or matte surface.

The voids are formed around the voiding agent as the polyester is stretched at or near the glass transition temperature, Tg, of the polymer. Because the particles of the void-forming composition are relatively hard compared to the polyester, the polyester separates from and slides over the voiding agent as it is stretched, causing voids to be formed in the direction or directions of stretch in which the voids elongate as the polyester continues to be stretched. Thus, the final size and shape of the voids depends on the direction(s) and amount of stretching. For example, if stretching is only in one direction, voids will form at the sides of the voiding agent in the direction of stretching. Typically, the stretching operation simultaneously forms the voids and orients the polyester. The properties of the final product depend on and can be controlled by manipulating the stretching time and temperature and the type and degree of stretch.

Optionally, in one embodiment, the oriented film is annealed at a temperature of about Tg to Tg plus 40° C. These annealing conditions after stretching allow the film to simultaneously maintain high shrinkage and low density.

As an example of a typical procedure for preparing the void-containing polyester film of the present disclosure, a polyester melt containing a uniformly dispersed voiding agent comprising the hollow glass microspheres is extruded through a slotted die at temperatures in the range of about 200° C. (400° F.) to about 280° C. (540° F.) and cast onto a chill roll maintained at about −1° C. (30° F.) to about 82° C. (180° F.). The film or sheet thus formed will generally have a thickness of about 100 um to about 1000 um. The film or sheet is then uniaxally or biaxially stretched in amounts ranging from about 200% (2×) to about 800% (8×) to provide an oriented film having a thickness of about 10 to about 100 um. It is also possible to combine void-containing layers with non-voided layers in a layered or laminated structure. For example, a non-voided layer can be bonded adjacent to void-containing layers or a voided layer can be bonded adjacent to non-voided layers to maximize density reduction and improve printing performance. After stretching, optionally the film is then annealed at a temperature between Tg and Tg plus 40° C. either continuously as part of the film stretching operation (e.g. in a tenter frame with a heatset zone), or offline. For example, the annealing is performed at a temperature of about 70° C. to about 110° C. For example, the annealing is performed at a temperature of about 80° C. to about 105° C. In another embodiment, the annealing is performed at a temperature from 90° C. to 100° C. In yet another embodiment, the annealing performed at a temperature between 80 and 85° C. Higher temperatures usually require shorter annealing times and are preferred for higher line speeds. Additional stretching after annealing can be performed, although not required.

For example, the film may be oriented in one direction, annealed at a temperature of 75° C. or higher, and oriented a second time in one or more directions.

In one embodiment, the shrinkable film is a single, monolayer film. In one embodiment, the shrinkable film is a multilayer film and has at least one layer A and at least one layer B. In one embodiment, the shrinkable film comprises a plurality of layers in which at least one layer comprises hollow glass microspheres.

In one embodiment, the film is a single, monolayer film. In one embodiment, the film is a multilayer film and has at least one layer A and at least one layer B. In one embodiment, the film comprises a plurality of layers in which at least one layer comprises hollow glass microspheres.

In one embodiment, the multilayer shrinkable film has at least one layer A, at least one tie layer, and at least one layer B. In one embodiment, the multilayer film further comprising a tie layer disposed between at least one layer A and at least one layer B.

In one embodiment, the multilayer film has at least one layer A, at least one tie layer, and at least one layer B. In one embodiment, the multilayer film further comprising a tie layer disposed between at least one layer A and at least one layer B.

In one embodiment, the multilayer shrinkable film has a three film layers comprising one layer A and two layers B or one layer A and one layer B and one layer C. In one embodiment, the multilayer shrinkable film has three film layers comprising three layers A or two layers A and one layer B. In one embodiment, the multilayer shrinkable film has at least three film layers comprising at least one layer A and at least one layer B and at least one tie layer. In one embodiment, the multilayer shrinkable film has five film layers comprising one layer A, two layers B, one each side of the layer A and a tie layer between the layer A and each layer B.

In one embodiment, the multilayer film has a three film layers comprising one layer A and two layers B or one layer A and one layer B and one layer C. In one embodiment, the multilayer film has a three film layers comprising three layers A or two layers A and one layer B. In one embodiment, the multilayer film has at least three film layers comprising at least one layer A and at least one layer B and at least one tie layer. In one embodiment, the multilayer film has five film layers comprising one-layer A and two layers B, with one-layer B one each side of the layer A and a tie layer between the layer A and each layer B (B-tie-A-tie-B).

In some embodiments, suitable tie layers comprise one or more copolymers selected from polyethylene copolymers, polypropylene copolymers, anhydride modified polyolefins, acid/acrylate modified ethylene vinyl acetate copolymer, acid modified ethylene acrylate, anhydride modified ethylene acrylate, modified ethylene acrylate, modified ethylene vinyl acetate, anhydride modified ethylene vinyl acetate copolymer, anhydride modified high density polyethylene, anhydride modified linear low density polyethylene, anhydride modified low density polyethylene, anhydride modified polypropylene, ethylene ethyl acrylate maleic anhydride copolymer and ethylene butyl acrylate maleic anhydride terpolymer, ethylene-alpha-olefin copolymers, alkene-unsaturated carboxylic acid or carboxylic acid derivative copolymers, ethylene-methacrylic acid copolymers, ethylene-vinyl acetate copolymers, ethylene-methacrylic acid copolymers, unsaturated dicarboxylic acid anhydride grafted copolymers, maleic anhydride grafted ethylene-vinyl acetate copolymers, maleic anhydride grafted polyethylene, styrene-butadiene copolymers, C3 or higher alpha-olefin copolymers having a high alpha-olefin comonomer content, propylene-1-butene copolymers, and mixtures thereof.

In one embodiment, the choice of tie layer resin depends on the compositions of the polymeric films to be bonded and on the adhesive strength required. In one embodiment, a tie layer is required when film layers of dissimilar chemistries are bonded together in an extrusion process. For example, when a polyolefin is bonded to a polyester in a multi-layer film. In one embodiment, non-reactive tie layer resins are used. In one embodiment, the non-reactive tie layer resins include ethylene vinyl acetate (EVA) and ethylene methyl acrylate copolymer (EMAC). In another embodiment, the non-reactive tie layer resins include acid modified olefin copolymers like ethylene acrylic acid (EAA) and ethylene methacrylic acid (EMAA). These resins are typically considered non-reactive since none or only a small portion of the acid groups undergo chemical reactions such as esterification. However, these resins still provide excellent adhesion to many polar polymers because they form strong hydrogen and polar bonds with many polar polymers such as nylon and polyesters. In another embodiment, reactive tie layer resins are used. For example, in one embodiment, a suitable reactive tie layer resin is anhydride modified polyethylene copolymers (AMP). In one embodiment, reactive tie layer resin adhesives are used when polyolefins are bonded to polyamides (nylons) or to ethylene vinyl alcohol copolymers (EVOH) or to polyesters. In these embodiments, the anhydride reacts with amine end groups to form imides and with alcohols to form ester crosslinks. In one aspect, an important parameter to consider is the amount of functionality in the tie resin. In one embodiment, AMPs can also be employed when no chemical reaction between the two resin layers takes place, as it is the case with PET and PVDC. In embodiments, with metalized films or aluminum foils, tie layer resins with acid functionalities are often the best choice. For example, in some embodiments, copolymers of ethylene and acrylic acid and/or methacrylic acid (EAA, EMAA) are employed for these applications which also bond well to nylon, but acrylate modified olefin resins (EMA) are a good choice in embodiments where the film has to adhere to inks and polyesters.

In one embodiment, the multilayer film or multilayer shrinkable film comprises a configuration of AB or BA, or ABA, or ABB, or BBA, or BAB, or AAB, or ABC. In one embodiment, each layer of the multilayer film or multilayer shrinkable film (layer A, layer B, or layer C) has the same polymer composition. In one embodiment, each layer of the multilayer film or multilayer shrinkable film (layer A, layer B, or layer C) has a different polymer composition. In one embodiment, one or more layers of the multilayer film or multilayer shrinkable film (layer A, layer B, or layer C) may have the same composition and one or more layers may have a different polymer composition. In one embodiment, at least one layer in the plurality of layers is voided.

In one embodiment, the laminate film comprises a configuration of AB or BA, or ABA, or ABB, or BBA, or BAB, or AAB, or ABC. In one embodiment, each layer of the laminate film (layer A, layer B, or layer C) has the same polymer composition. In one embodiment, each layer of the laminate film (layer A, layer B, or layer C) has a different polymer composition. In one embodiment, one or more layers of the laminate film (layer A, layer B, or layer C) may have the same composition and one or more layers may have a different polymer composition. In one embodiment, at least one layer in the plurality of layers is voided.

In one embodiment, at least one layer, layer A or layer B or layer C, is printable.

One embodiment of the present disclosure is the use of the multilayer film in packaging and/or labeling applications. Another embodiment is the use of the multilayer shrinkable film of the present disclosure in packaging and/or labeling applications.

One embodiment is a label or sleeve comprising the multilayer film of the present disclosure. Another embodiment, is a label or sleeve comprising the multilayer shrinkable film of the present disclosure.

One embodiment of the present disclosure is a film laminate comprising at least one layer A comprising a at least one polymer and at least one layer B comprising at least one polymer and hollow microspheres and optionally at least one adhesive disposed between at least one layer A and at least one layer B.

In the present disclosure, lamination is the technique of manufacturing a material in multiple layers, so that the composite material achieves improved strength, stability, sound insulation, printability, appearance or other properties from the use of differing materials. A laminate is a permanently assembled object by bonding heat, pressure, welding, extrusion or adhesives. For many applications in flexible packaging, the use of a single material may not satisfy all of the properties demanded of the product. In these cases, a laminate composite consisting of two or more layers of material may provide the desired performance. A particularly common means of creating such a laminate is to laminate various polymeric films to other films, foils, papers, etc. with a polymeric adhesive. This production solution is commonly employed in the packaging industry where the end products require multi-functional properties, such as high tensile strength or high gas permeability. In general, these are referred to as barrier films. The laminate construction can become rather complicated due to the nature of the specific application. For example, a laminate for use in the medical packaging may be a multi-layer composite containing films of polyester/polyethylene/metal foil/polyethylene.

In one embodiment, the laminating adhesives that are useful in the present disclosure can be formulated in a variety of ways. For example, in one embodiment, the laminating adhesives useful for this disclosure can be solvent borne, solvent less, waterborne, radiation curable, or a combination radiation curable. The method used is based on the adhesive formulation, how the adhesive is applied, and how it is used to bond the different layers of the laminate. In one embodiment, suitable adhesive formulations can include resin with the following chemistries: polyether urethanes, polyesters, polyester urethanes, acrylics, and mixtures thereof. The choice of adhesive resins is made to optimize the processing and performance of the laminating adhesive to provide optimum bonding strength, flexibility, and other performance properties in the application.

In one embodiment, the multilayer sheets or films (or laminates) are made using one of the following methods: coextruding, extrusion laminating or adhesive laminating. In embodiments where coextrusion is used, multiple layers of polymers are generated by melting the polymers compositions for each layer in different extruders, and in some cases, the extruders are attached to a co-ex block or co-ex die. The polymers from the different extruders come together in the block or die while melted and then exit the die as a multi-layer sheet or film. Extrusion laminating is a process that takes at least two films (mono or co-ex) and they are bonded together by extruding a polymer melt in the middle of the two films and creating a multilayer film. Adhesive laminating takes at least two films (mono or co-ex) and bonds them together using a liquid adhesive which creates a multilayer film. Multiple combinations and multiple layers can be made using these methods.

In some embodiments with extrusion lamination the adhesive resins comprise one or more copolymers selected from polyethylene copolymers, polypropylene copolymers, anhydride modified polyolefins, acid/acrylate modified ethylene vinyl acetate copolymer, acid modified ethylene acrylate, anhydride modified ethylene acrylate, modified ethylene acrylate, modified ethylene vinyl acetate, anhydride modified ethylene vinyl acetate copolymer, anhydride modified high density polyethylene, anhydride modified linear low density polyethylene, anhydride modified low density polyethylene, anhydride modified polypropylene, ethylene ethyl acrylate maleic anhydride copolymer and ethylene butyl acrylate maleic anhydride terpolymer, ethylene-alpha-olefin copolymers, alkene-unsaturated carboxylic acid or carboxylic acid derivative copolymers, ethylene-methacrylic acid copolymers, ethylene-vinyl acetate copolymers, ethylene-methacrylic acid copolymers, unsaturated dicarboxylic acid anhydride grafted copolymers, maleic anhydride grafted ethylene-vinyl acetate copolymers, maleic anhydride grafted polyethylene, styrene-butadiene copolymers, C3 or higher alpha-olefin copolymers having a high alpha-olefin comonomer content, propylene-1-butene copolymers, and mixtures thereof.

The following examples further illustrate how the films and shrinkable films of the present disclosure can be made and evaluated, and they are intended to be purely exemplary and are not intended to limit the scope thereof. Unless indicated otherwise, parts are parts by weight, temperature is in degrees C. (Celsius) or is at room temperature, and pressure is at or near atmospheric.

### EXAMPLES

The present disclosure is explained using the examples that follow. The disclosure is not limited by these examples and can be modified within the scope of the present disclosure. General test methods followed standard ASTM procedures wherever possible. Glass transition temperatures were determined by DSC using ASTM Method D3418. Light transmittance was measured using procedures described in ASTM E1348-02 and ASTM D1003. Surface Gloss was measured using procedures described in ASTM D523.

The film resin compounds were made using standard compounding processes. Additives and resins were compounded together using a twin-screw extruder and then pelletized. The pelletized compounds were then converted into films using 2 different processes.

In the lab scale process, all materials were extruded into films using a 1-inch Killion extruder L/D=24:1 at melt temperatures from 465 to 480° F. The film samples were stretched on a Bruckner Film stretcher at a temperature between Tg and Tg+15° C. In most cases, the films were stretched at a 5:1 stretch ratio. In some cases, this stretch ratio was reduced to make viable shrink film samples. After the shrink film samples were made, the film properties were measured.

In the commercial tenter frame process, stretching of the extruded cast films were performed on a commercial tenter frame. The stretching conditions, including stretch ratio, preheat temperature (Zone 1), stretch temperature (Zone 2) and anneal temperature (Zone 3) was varied from sample to sample. In most cases, the line speeds were nominally 40 to 50 feet per minute (fpm). The extruders used to make films in this commercial tenter frame process was also used to make both the multi-layer film structures and the monolayer film structures.

The films were typically stretched at temperatures 10-15° C. greater than the Tg of the polymer resin used in both the lab-scale and the commercial tenter frame processes. Commercial shrink films are often stretched at a ratio of 5:1 in the TD direction. All films evaluated were stretched at the highest stretch ratio possible without film breaks. Films were also stretched at slower stretch speeds to ensure highest stretch ratio possible.

An amorphous polyester (resin 5, Table A), was combined with various voiding agents using a twin-screw extruder. The voiding agents evaluated included polypropylene (P4G3Z 039, available from Flint Hills Co., 5 melt flow rate), ethylene methyl acrylate copolymer (SP 2260, EMAC available from Westlake), hollow glass microspheres (iM16K available from 3M), acrylic beads (Altuglas BS100 available from Arkema), and mixtures of immiscible polymers (cellulose acetate 398-30 available from Eastman Chemical Company, polypropylene P4G37-039 available from Flint Hills, and ethylene methyl acrylate copolymer, EMAC, available from Westlake). In some case, titanium dioxide (W-39, Tipure R-101; 0.29 micron particle size; available from the Chemours Company) was added to increase the opacity of the film (reduce the light transmission). In some cases, the compounded products were pelletized for ease of handling and then combined with neat copolyester in a specific ratio to result in a chosen amount of voiding agent in the final extruded film. Each film was extruded using a single screw extruder followed by film stretching in either the lab scale process or the commercial tenter frame process. Film samples were then evaluated for ultimate shrinkage at 95° C., for density after shrinking at 95° C. for 10 seconds, and for light transmission. Shrink films were also produced from copolyester resins as described in Table A. These copolyester resins were all made using typical copolyester manufacturing processes known to those skilled in the art.

Film densities before and after shrinkage were obtained by immersing small pieces of the film in fluids of known density. The fluid density which caused the film sample to float was taken to be the film density. For densities from 0.80 g/cc to 1 g/cc, these fluids were produced from blends of ethanol and water and calibrated against a hydrometer. For densities above 1 g/cc, the control fluids were blended in a similar manner using salt and water. Solutions having various specific gravities between 0.75 g/m and 1.4 g/m were used.

Shrinkage properties were measured by immersing the stretched films of known length in a hot water bath at desired temperature for 10 seconds. Shrinkage is reported as change in length divided by original length times 100%. The size of the sample films tested was 10 cm by 10 cm. The change in length in each direction was recorded and plotted against the temperature. Shrinkage properties were measured at 60, 65, 70, 75, 80, 85, 90 and 95° C. The shrinkage at 95° C. after 10 seconds is reported as the ultimate shrinkage.

TABLE A
Copolyester resin components

| Composition (%) | Resin 1 | Resin 2 | Resin 3 | Resin 4 | Resin 5 |
|---|---|---|---|---|---|
| Terephthalic acid | 100 | 100 | 100 | 100 | 100 |
| Ethylene glycol | 94 | 71 | | | 65 |
| 1,4-cyclohexane | 4 | | 78 | 77 | 23 |
| dimethanol | | | | | |
| 2,2,4,4-dimethyl | | | 22 | 23 | |
| cyclobutane-1,3-diol | | | | | |
| 2,2-dimethyl propane- | | 26 | | | |
| 1,3-diol | | | | | |
| diethylene glycol | 2 | 3 | | | 12 |

Concentrates were produced by compounding hollow glass microspheres (iM16K, available from 3M Company) with 2 different polymer compositions. Concentrate 1 was made using 60% polypropylene (P4G3Z-039, available from Flint Hills), 10% of ethylene methyl acrylate copolymer (SP2260, available from Westlake Chemical) and 30% of hollow glass microspheres (iM16K available from 3M). Concentrate 2 was made using 59% resin 5 (Table A) copolyester resin and 41% hollow glass microspheres. The concentrates were prepared using a twin-screw extruder. All of the components were combined, and they were heated to 280° C. to form a strand and a rotating wheel was used to cut the strand into pellets. The concentrates can be produced using any procedures known in the art.

The shrink films were produced by extruding resin 5 (Table A) with either of these compounded concentrates to the desired thickness by stretching to a ratio 4× to 6× in the transverse direction on a tenter frame.

### Examples 1-3

In these examples 1-3, the samples were produced as three-layer films (A-B-A), co-extruded using single screw extruders for each layer of the films. The layers B were made up of Resin 5 (Table A) and concentrate 1 at various loading levels for each sample produced. The resulting quantities of materials contained in layer B based on these loading levels are shown in Table 1. The Layers A contained 100% Resin 5 (Table A) or contained about 99% Resin 5 (Table A) and about 1% C0235 anti-block slip agent (available from Eastman Chemical Company). Example 3 performed well and yielded retention of low density, excellent shrink characteristics, a smooth surface to allow for printing, and light blocking functionality. Example 1 did not perform as well because the density after shrinkage is greater than 1 so it did not float.

Stretching of the cast film was performed using the commercial tenter frame process. The stretching included a preheat temperature, a stretch temperature, and an anneal temperature. The line speed was about 45 feet per minute (fpm). Stretching conditions for each of the samples are shown in Table 1.

Initial density values were obtained after shrinkage in 95° C. water for 10 seconds. Samples were placed in solutions of known densities to determine floatability. These solutions were made by combining water and ethanol or water and potassium bromide to form solutions of known densities ranging from 0.85 g/cc to 1.1 g/cc. The range above was 0.80 to 1.0. The film pieces were cut out and placed in these solutions to determine the density of the sample. The density values are summarized in Table 1.

TABLE 1

| Example # | 1 | 2 | 3 |
|---|---|---|---|
| Resin 5 (Table A) (%) | 75 | 65 | 67 |
| Polypropylene (%) | 15 | 21 | 19.8 |
| EMAC (%) | 2.5 | 3.5 | 3.3 |
| Hollow Glass Microspheres (%) | 7.5 | 10.5 | 9.9 |
| Stretch Ratio | 5.0 | 5.0 | 5.0 |
| Preheat Temperature, (° C.) | 77.8 | 77.8 | 77.8 |
| Stretch Temperature, (° C.) | 79.4 | 79.4 | 79.4 |
| Anneal Temperature, (° C.) | 76.1 | 76.1 | 76.1 |
| % Shrinkage after 10 seconds at 95° C. | 75.5 | 76 | 76 |
| Density after shrinkage (10 | >1.0 | <0.85 | <0.85 |
| seconds @ 95° C.), g/cc | | | |

The density of the film described in Table 1 as example 3 was measured using two different procedures. The calculated density was determined by cutting the samples using a precise die cutting machine that were 100 cm². The thickness was measured using a micrometer. The volume of the film was calculated using the area calculation and thickness measurement. The weight of the samples was determined using a balance. The density of the films was calculated based on the measured weight and volume. The weight of the shrink film was calculated by averaging the combined weight of 53 precisely cut samples at 100 cm². The calculated density of the shrink film was determined by dividing the average measured weight by the volume of the sample. The calculated density after shrinkage was determined by using the same procedure on ten 100 cm² samples that had been shrunk in a water bath at 95° C. for 10 seconds. The samples were weighed using a lab balance to determine an average weight. The volume was calculated by averaging the volume of the 10 samples. The average weight of the samples was divided by the average volume of the 10 samples to give the calculated after shrinkage density. In other samples, the measured density of the films was determined using ASTM D1622-08. The average density values are listed in Table 2.

TABLE 2
Average Density Values (g/cc)

| | |
|---|---|
| Calculated Density | Measured Density |

| Before | After | Before | After |
|---|---|---|---|
| Shrinkage | Shrinkage | Shrinkage | Shrinkage |
| 0.54 | 0.66 | 0.54 | 0.75 |

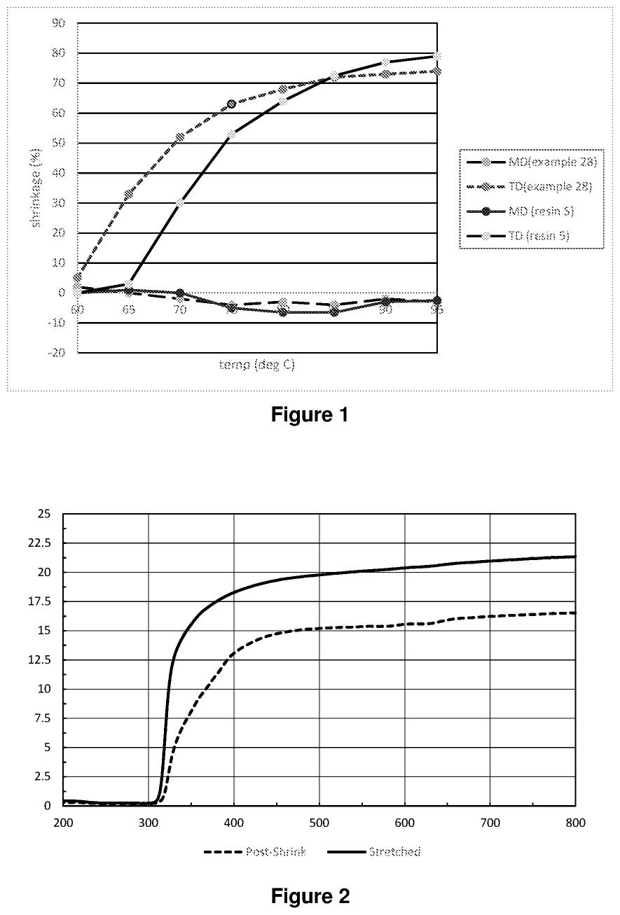

The shrink curve for Example 3 is shown in FIG. 1 and is plotted with the shrink curve of comparative example #1, which was made from Resin 5 (Table A), a non-voided shrinkable film resin. The highest level of TD shrinkage (95° C.) was about 75%. The shrink films of the present disclosure have unique shrink properties and exhibit MD growth. The film shows MD growth of 5% over temperature range of 70 to 95° C.

Light transmittance was measured using UV-VIS spectrometer by collecting spectrum in the range of 200 to 800 nm with integrating sphere accessory. The method used for measuring light transmittance was ASTM E1348-02. The transmittance of the shrink film described by example 3 was less than about 22% for the stretched film and less than about 16% for the post-shrinkage specimen in the visible range. The transmittance curves are shown in FIG. 2.

The films with low density and good film quality were floatable, with uniform dispersion of voids, had high opacity, a smooth surface, and good strength. Film samples with higher density and poor film quality did not float.

Porosity was measured on the film described by Example #3 using a scanning electron microscope (SEM). The samples were cut perpendicular to the machine direction (MD). The samples were soaked in liquid nitrogen and microtomed. The film specimens were gold sputtered and analyzed at 1000× and 2000× magnification for porosity measurement. The average porosity of shrink films samples from the present disclosure was 58% in the voided layer and the core/center layer. The control had 0% porosity.

### Comparative Examples 1-4

Comparative Example 1 represents a commercial non-voided shrinkable film. It had a density of 1.3 g/cc, so it did not float in water after shrinkage at 95° C. for 10 seconds. Comparative Example 1 was made using typical stretching conditions that could be used to make such a shrink film. Comparative Example 1 contained no voiding agent and was used for comparison of shrink characteristics. Comparative example #2 is an immiscible polymer blend used to make cavitated films. Comparative example #3 is similar to comparative example #2 except that it does not contain cellulose acetate. Comparative example #4 shows the effect of adding hollow glass microspheres to a typical shrink film resin like comparative Example #1 (Resin 5 (Table A)). Example #1 shows the effect of adding immiscible polymers in addition to hollow glass microspheres. The combination of hollow glass microspheres with immiscible polymers creates a film with a density less than 1.0 (i.e. would float in water). This density for the combined additives, is much lower than either of the components added alone. In addition, the light transmission is very low and the ultimate shrinkage for each film is greater than 70%. Example #1 describes a high opacity, low density film with high ultimate shrinkage that would create an excellent shrink film material that could be easily recycled as it would float in water and be removed from PET flake during recycling. All samples were made using the Lab-scale process.

TABLE 3
Comparative Examples

| | | | Comparative | Comparative | Comparative |
|---|---|---|---|---|---|
| | | Comparative | Example #2 | Example #3 | Example #4 |
| | Example | Example #1 | (Same as | (Same as | (Same as |
| | #1 | (resin 5) | Example #15) | Example #2) | Example #7) |
| Resin 5 (Table A) (wt %) | 69.5 | 100 | 75 | 85 | 90 |
| Polypropylene (wt %) | 15 | | 8.75 | 15 | |
| EMAC (wt %) | 3 | | 2.5 | 3 | |
| Hollow Glass | 10 | 0 | 0 | 0 | 10 |
| Microspheres (wt %) | | | | | |
| TiO₂ (wt %) | 2.5 | 0 | 0 | 0 | 0 |
| Cellulose Acetate (wt %) | | | 13.75 | | |
| Ultimate Shrinkage (%) | 72 | 78 | 76 | 76 | 74 |
| Shrunk Density (g/ml) | 0.82 | 1.3 | 1.2 | 1.23 | 1.03 |
| Light Transmittance (%) | 21 | | 33 | 83 | 63 |
| Glass Transition | 69 | 70 | 70 | 69 | 75 |
| Temperature (° C.) | | | | | |
| Stretch Temperature (° C.) | 80 | 80 | 80 | 80 | 85 |
| Stretch Ratio (TD:MD) | 5:1 | 5:1 | 5:1 | 5:1 | 5:1 |
| 60° Gloss | 6.2 | | 6.6 | | |

### Examples 4-8

Evaluations of films made with the compositions described in Table 4 for Examples 4 through 8 show how the ratio of the amount of immiscible polymers like polypropylene and EMAC affects the properties of the film. Density and ultimate shrinkage are very similar across the studied compositions. Light transmission decreases as the amount of immiscible polymer in the composition increases. None of these examples had a film density less than 1.0.

TABLE 4
Composition and properties of films compounded with
Resin 5 (Table A), Polypropylene, and EMAC.

| | Example 4 | Example 5 | Example 6 | Example 7 | Example 8 |
|---|---|---|---|---|---|
| Resin 5 (Table A) (wt %) | 88 | 85 | 79 | 77 | 74 |
| Polypropylene (wt %) | 9 | 15 | 15 | 20 | 20 |
| EMAC (wt %) | 3 | 3 | 6 | 3 | 6 |
| Ultimate Shrinkage (%) | 77 | 76 | 77 | 75 | 72 |
| Shrunk Density (g/ml) | 1.23 | 1.23 | 1.17 | 1.17 | 1.17 |
| Light Transmittance (%) | 87.9 | 82.7 | 83.6 | 78.1 | 83.0 |
| Glass Transition | 69 | 69 | 69 | 69 | 69 |
| Temperature (° C.) | | | | | |
| Stretch Temperature | 80 | 80 | 80 | 80 | 80 |
| (° C.) | | | | | |
| Stretch Ratio (TD:MD) | 5:1 | 5:1 | 5:1 | 5:1 | 5:1 |

### Examples 9-12

Evaluations of films made with the compositions described in Table 5 for Examples 9-12 show how the concentration of hollow glass microspheres affect the film properties of the corresponding shrink film. In these examples, density and light transmission decreases in corresponding shrinkable films as the concentration of hollow glass microspheres increases. These shrinkable films also have very high ultimate shrinkage. Examples 9 and 10 both had a film density greater than 1.0 and would not float in water.

TABLE 5
Composition and properties of films compounded with
Resin 5 (Table A) and Hollow Glass Microspheres.

| Sample ID | Example 9 | Example 10 | Example 11 | Example 12 |
|---|---|---|---|---|
| Resin 5 (Table A) (wt %) | 95 | 90 | 80 | 70 |
| Hollow Glass Microspheres (wt %) | 5 | 10 | 20 | 30 |
| Ultimate Shrinkage (%) | 74 | 74 | 75 | 64 |
| Shrunk Density (g/ml) | 1.17 | 1.02 | 0.91 | 0.82 |
| Light Transmittance (%) | 77.2 | 63.0 | 48.4 | 48.5 |
| Glass Transition Temperature (° C.) | 75 | 75 | 75 | 75 |
| Stretch Temperature (° C.) | 85 | 85 | 85 | 80 |
| Stretch Ratio (TD:MD) | 5:1 | 5:1 | 5:1 | 3.5:1 |

### Example 13

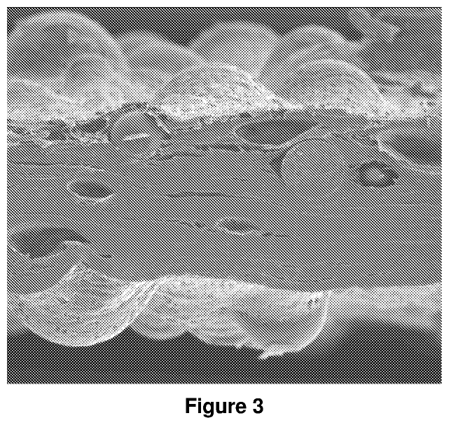

The use of solid acrylic beads does not have the same effect on density as the hollow glass microspheres. Example 13 was made with Altuglas BS100 (sold by Arkema) in combination with immiscible polymers evaluated in previous examples. This bead had little effect on density even when added at a level of 10%. The SEM image of the film (FIG. 3) shows that the acrylic bead is more intimately bonded with the surrounding resin and does not form discrete voids around the bead to reduce density like the glass microspheres. Additionally, the acrylic bead is not hollow, it is solid, so does not provide the same density reduction as a hollow microsphere.

TABLE 6
Composition and properties of films
compounded with Resin 5 (Table A),

| Sample ID | Example 13 |
|---|---|
| Resin 5 (Table A) (wt %) | 72 |
| Polypropylene (wt %) | 15 |
| EMAC (wt %) | 3 |
| Acrylic Beads (wt %) | 10 |
| Ultimate Shrinkage (%) | 75 |
| Shrunk Density (g/ml) | 1.2 |
| Light Transmittance (%) | 74 |
| Glass Transition Temperature (° C.) | 75 |
| Stretch Temperature (° C.) | 80 |
| Stretch Ratio (TD:MD) | 5:1 |

### Example 14-17

Examples 14 to 17 show the effect of base polyester resin on the film properties. Low density and low light transmission films were made in all cases.

TABLE 7
Composition and properties of films compounded
with various polyester compositions.

| | Example | Example | Example | Example |
|---|---|---|---|---|
| Sample ID | 14 | 15 | 16 | 17 |
| Resin 1 (wt %) | 67 | | | |
| Resin 2(wt %) | | 67 | | |
| Resin 3(wt %) | | | 67 | |
| Resin 4 (wt %) | | | | 67 |
| Polypropylene (wt %) | 20 | 20 | 20 | 20 |
| EMAC (wt %) | 3 | 3 | 3 | 3 |
| Hollow Glass | 10 | 10 | 10 | 10 |
| Microspheres (wt %) | | | | |
| Ultimate Shrinkage | 22 | 62 | 42 | 1 |
| (%, at 95° C.) | | | | |
| Shrunk Density (g/ml) | 0.8 | 0.9 | 0.9 | 0.9 |
| Light Transmittance (%) | 26 | 36 | 48 | 39 |
| Glass Transition | 81 | 76 | 95 | 110 |
| Temperature (° C.) | | | | |
| Stretch Temperature | 90 | 90 | 110 | 120 |
| (° C.) | | | | |
| Stretch Ratio (TD:MD) | 4:1 | 4:1 | 3:1 | 2:1 |

### Examples 18-20

Examples 18-20 show the effect of adding hollow glass microspheres to a commercial micro-voiding compound. The hollow glass microspheres are added to a voiding additive made with immiscible polymers (CA, PP, EMAC) and then combined with a shrinkable film resin (Resin 5 (Table A)). The addition of hollow glass microspheres does reduce density and light transmission of the resulting film. The addition of hollow glass microspheres does not adversely affect ultimate shrinkage of the film.

TABLE 8
Composition and properties of voided films compounded with Resin
5 (Table A) with and without and Hollow Glass Microspheres.

| | Example | Example | Example |
|---|---|---|---|
| Sample ID | 18 | 19 | 20 |
| Resin 5 (Table A) (wt %) | 75 | 73 | 70 |
| Cellulose Acetate (wt %) | 13.75 | 13.75 | 13.75 |
| Polypropylene (wt %) | 8.75 | 8.75 | 8.75 |
| EMAC (wt %) | 2.5 | 2.5 | 2.5 |
| follow Glass Microspheres (wt %) | 0 | 2 | 5 |
| Ultimate Shrinkage (%) | 76 | 75 | 74 |
| Shrunk Density (g/ml) | 1.2 | 1.0 | 1.0 |
| Light Transmittance (%) | 33 | 27 | 19 |
| Glass Transition | 70 | 75 | 75 |
| Temperature (° C.) | | | |
| Stretch Temperature (° C.) | 80 | 80 | 80 |
| Stretch Ratio (TD:MD) | 5:1 | 5:1 | 5:1 |

### Example 21-25

Examples 21-25 show the effects of adding opacifiers to the micro-voiding composition. For opaque, low density film applications, low light transmission is required. Table 9 shows that opacifiers can be added to the compounded compositions to further decrease light transmission. TiO2 was more effective than the combination of immiscible polymers (CA, PP, EMAC) at the same additive level and the addition of TiO2 does not reduce the ultimate shrinkage of the micro-voided films.

TABLE 9
Evaluation of Opacifiers

| | Example | Example | Example | Example | Example |
|---|---|---|---|---|---|
| | 21 | 22 | 23 | 24 | 25 |
| Resin 5 (Table A) (wt %) | 72 | 71 | 69.5 | 70 | 67 |
| Polypropylene (wt %) | 15 | 15 | 15 | 15.7 | 16.75 |
| EMAC (wt %) | 3 | 3 | 3 | 3.2 | 3.5 |
| Hollow Glass | 10 | 10 | 10 | 10 | 10 |
| Microspheres | | | | | |
| TiO2(wt %) | 0 | 1 | 2.5 | 0 | 0 |
| Cellulose Acetate (wt %) | | | | 1.1 | 2.75 |
| Ultimate Shrinkage (%) | 72 | 70 | 72 | 69 | 61 |
| Shrunk Density (g/ml) | 0.9 | 0.9 | 0.9 | 0.9 | 0.9 |
| Light Transmittance (%) | 26 | 22 | 16 | 23 | 19 |
| Stretch Temperature | 85 | 85 | 85 | 85 | 85 |
| (° C.) | | | | | |
| Stretch Ratio (TD:MD) | 5:1 | 5:1 | 5:1 | 5:1 | 5:1 |

### Examples 26 and 27

In example 26, Resin 5 (Table A) was blended with concentrate 2 (59% Resin 5 (Table A), 41% Hollow Glass Microspheres) to form one of the layers (B) of the co-extruded structure made using the commercial tenter frame process. The sample produced was a three-layer structure, co-extruded using single screw extruders for each layer of the articles. The Layers A consisted of Resin 5 (Table A) copolyester. The Layers A contained of 100% Resin 5 (Table A) or contained about 99% Resin 5 (Table A) and about 1% C0235 anti-block slip agent (available from Eastman Chemical Company).

Example 27 was produced using a blend of Resin 5 (Table A) and concentrate 2 in three layers A to form the co-extruded film (A-A-A). This sample retained very low density but yielded a surface that lack some smoothness, so it may not be ideal for some printing processes.

Stretching of the cast film was performed on a commercial tenter frame. The stretching included a preheat temperature, a stretch temperature, and an anneal temperature. The line speed was about 45 fpm. Stretching conditions for each are shown in Table 10.

Density values were obtained using the same procedure as described for the examples listed above and the density values are shown in Table 10.

TABLE 10

| Example # | 26 (A-B-A) | 27 (A-A-A) |
|---|---|---|
| % Concentrate | 30% | 25% |
| Resin 5 (Table A) (wt %) | 87.7 | 89.7 |
| Hollow Glass (wt %) | 12.3 | 10.3 |
| Microspheres (wt %) | | |
| Stretch Ratio | 5.0 | 5.0 |
| Preheat Temperature (° C.) | 82.2 | 82.2 |
| Stretch Temperature (° C.) | 82.2 | 82.2 |
| Anneal Temperature (° C.) | 82.2 | 82.2 |
| % Shrinkage after 10 | 72 | 71 |
| seconds at 95° C. | | |
| Density after shrinkage (10 | <0.85 | <0.85 |
| seconds @ 95° C.), g/cc | | |

### Examples 28-31

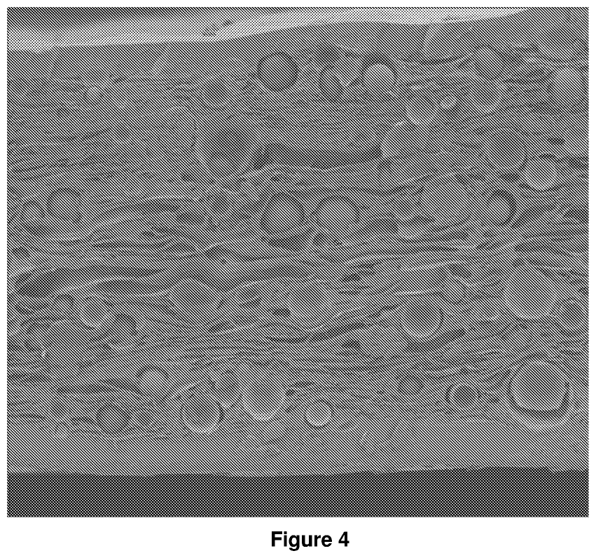

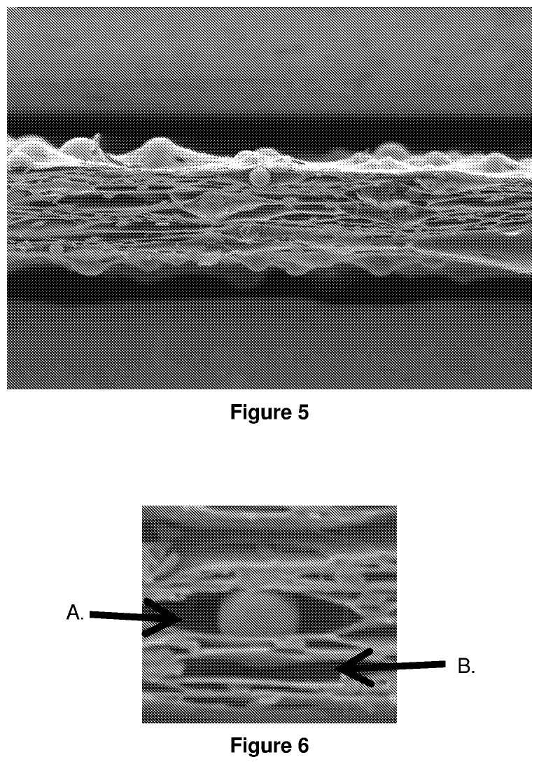

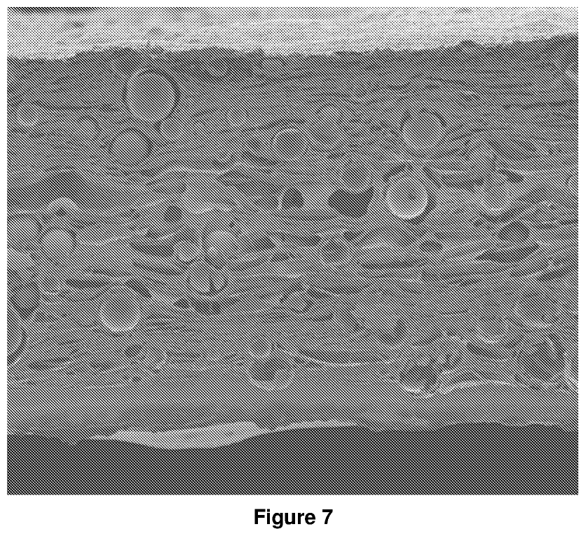

Examples 28-31 show the effect of film structure. Example 28 is a monolayer film and examples 29-31 were all multilayer films. Multilayer films are made as an A-B-A multilayer film with Resin 5 (Table A) as the cap layer material (the A layer) extruded adjacent to a core, voided layer. All films were made on a commercial tenter. All films had low density, low light transmission, and high ultimate shrinkage. The main difference was the gloss of the film surface. Materials made with an Resin 5 (Table A) cap-layer had much higher gloss than a monolayer film. FIGS. 4-7 shows SEM images of a micro-voided films. In FIGS. 5 and 6, you see the cavitation created by the immiscible polymers and the voids created around the hollow glass microspheres (the broken microspheres in the images were created during the cutting process to prepare the film for imaging and not during the compounding or film formation processes).

TABLE 11
Films made on a commercial tenter frame

| | Example 28 | Example 29 | Example 30 | Example 31 |
|---|---|---|---|---|
| | (Mono T) | (Co-Ex) | (Co-ex) | (Co-EX) |
| Resin 5 (Table A) (wt %) | 69.5 | 72 | 70 | 69.5 |
| Polypropylene (wt %) | 15 | 15 | 15 | 15 |
| EMAC (wt %) | 3 | 3 | 3 | 3 |
| Hollow Glass | 10 | 10 | 10 | 10 |
| Microspheres (wt %) | | | | |
| TiO2 (wt %) | 2.5 | 0 | 2 | 2.5 |
| Ultimate Shrinkage (%) | 74 | 74 | 74 | 72 |
| Shrunk Density (g/ml) | 0.9 | 0.8 | 0.8 | 0.8 |
| Light Transmittance (%) | 30 | 51 | 39 | 30 |
| Skin thickness (microns) | 0 | 2 | 3 | 3 |
| Core thickness (microns) | 34 | 27 | 32 | 34 |
| 60 deg gloss | 6.3 | 22 | 32 | 15 |
| Preheat temperature (° C.) | 78 | 78 | 78 | 78 |
| Stretch Temperature (° C.) | 79 | 79 | 79 | 79 |
| Anneal Temperature (° C.) | 76 | 76 | 76 | 76 |
| Stretch Ratio (TD:MD) | 5:1 | 5:1 | 5:1 | 5:1 |

### Example 32: Multilayer Film with 2 Voided Layers

Example 32 shows the effect of making a multilayer films where 2 voided layers are co-extruded adjacent to cone another. This film was extruded with a non-voided layer on one side and a voided layer on the other side with a voided core layer, containing glass bubbles. This film structure has the advantage of different surface roughness on the different sides but with a low overall density.

TABLE 12
Multilayer film with 2 Voided Layers

| Sample ID | Example 32 |
|---|---|
| Layer A | Comparative Example 2 |
| Layer B | Example 21 |
| Layer C | Comparative Example 1 |
| Ultimate Shrinkage (%) | 74 |
| Shrunk Density (g/ml) | 0.85 |
| Stretch Temperature Preheat | 78 |
| Zone (° C.) | |
| Stretch Temperature Stretch | 79 |
| Zone (° C.) | |
| Stretch Temperature Anneal | 76 |
| Zone (° C.) | |
| Stretch Ratio (TD:MD) | 5:1 |

1.-4. (canceled)

5. A voided film comprising:
(1) 70-99 wt % of a polymer composition comprising at least one polymer selected from acrylic polymers, polyolefins, cellulose esters, cellulose acetate, cellulose triacetate, cellulose propionate, cellulose butyrate, cellulose acetate propionate, cellulose acetate butyrate, cellulose propionate butyrate, cyclic olefin copolymers, ethylene methyl acrylate copolymer, polycarbonate, polypropylene, polystyrene, polystyrene butadiene copolymers or blends, polyethylene, ethylene/propylene copolymer, ethylene-vinyl acetate (EVA), ethylene vinyl alcohol copolymer, polyvinyl chloride, poly(lactic acid), polyvinylidene chloride, nylon, polyethylene terephthalate (PET), polyesters, copolyesters, and mixtures thereof; and
(2) 1-30 wt % of hollow glass microspheres; wherein the at least one polymer comprises a polyester composition comprising: at least one polyester which comprises
(a) a dicarboxylic acid component comprising:
(i) 70 to 100 mole % of terephthalic acid residues, and
(ii) 0 to 30 mole % of aromatic and/or aliphatic dicarboxylic acid residues having up to 20 carbon atoms; and
(b) a glycol component comprising:
(i) 0 to 40 mole % 2,2-dimethylpropane-1,3-diol (neopentyl glycol or NPG) residues;
(ii) 0 to 100 mole % 1,4-cyclohexanedimethanol (CHDM) residues;
(iii) 0 to 45 mole % 2,2,4,4-tetramethyl-1,3-cyclobutanediol (TMCD) residues;
(iv) 0 to 40 mole percent diethylene glycol (DEG) residues, whether or not formed in situ;
wherein the remainder of the glycol component comprises:
(v) residues of ethylene glycol, and
(vi) optionally, 0 to 10 mole % of the residues of at least one other modifying glycol;
wherein the total mole % of the dicarboxylic acid component is 100 mole %, and wherein the total mole % of the glycol component is 100 mole %.

6. (canceled)

7. A voided film comprising:
(1) 70-99 wt % of a polymer composition comprising at least one polymer selected from acrylic polymers, polyolefins, cellulose esters, cellulose acetate, cellulose triacetate, cellulose propionate, cellulose butyrate, cellulose acetate propionate, cellulose acetate butyrate, cellulose propionate butyrate, cyclic olefin copolymers, ethylene methyl acrylate copolymer, polycarbonate, polypropylene, polystyrene, polystyrene butadiene copolymers or blends, polyethylene, ethylene/propylene copolymer, ethylene-vinyl acetate (EVA), ethylene vinyl alcohol copolymer, polyvinyl chloride, poly(lactic acid), polyvinylidene chloride, nylon, polyethylene terephthalate (PET), polyesters, copolyesters, and mixtures thereof; and
(2) 1-30 wt % of hollow glass microspheres; wherein the at least one the polymer comprises a polyester composition comprising: at least one polyester which comprises
(a) a dicarboxylic acid component comprising:
(i) 70 to 100 mole % of terephthalic acid residues, and
(ii) 0 to 30 mole % of aromatic and/or aliphatic dicarboxylic acid residues having up to 20 carbon atoms; and
(b) a glycol component comprising:
(i) 0 to 40 mole % 1,4-cyclohexanedimethanol (CHDM) residues;
(ii) 5 to 40 mole % 2,2-dimethylpropane-1,3-diol (neopentyl glycol or NPG) residues;
(iii) 0 to 20 mole % diethylene glycol (DEG) residues, whether or not formed in situ;
wherein the remainder of the glycol component comprises:
(iv) residues of ethylene glycol, and
(v) optionally, 0 to 15 mole % of the residues of at least one other modifying glycol;
wherein the total mole % of the dicarboxylic acid component is 100 mole %, and wherein the total mole % of the glycol component is 100 mole %; or wherein the at least one polymer comprises a polyester composition comprising:
(1) 5-80% of at least one crystallizable polyester which comprises:
(a) a dicarboxylic acid component comprising:
(i) 70 to 100 mole % of terephthalic acid residues;
(ii) 0 to 30 mole % of aromatic and/or aliphatic dicarboxylic acid residues having up to 20 carbon atoms; and
(b) a glycol component comprising:
75 mole % or greater of ethylene glycol residues and
25 mole % or less of other glycols comprising one or more of:
(i) 0 to less than 25 mole % neopentyl glycol residues;
(ii) 0 to less than 25 mole % 1,4-cyclohexanedimethanol residues;
(iii) 0 to less than 10 mole % total diethylene glycol residues, whether or not formed in situ;
wherein the total mole % of the dicarboxylic acid component is 100 mole %, and wherein the total mole % of the glycol component is 100 mole %; and
(2) 20-95% of at least one amorphous polyester which comprises:
(a) a dicarboxylic acid component comprising:
(i) 70 to 100 mole % of terephthalic acid residues;
(ii) 0 to 30 mole % of aromatic and/or aliphatic dicarboxylic acid residues having up to 20 carbon atoms; and
(b) a glycol component comprising:
60 mole % or greater of ethylene glycol residues and
40 mole % or less of other glycols comprising one or more of:
(i) 0 to less than 40 mole % neopentyl glycol residues;
(ii) 0 to less than 40 mole % 1,4-cyclohexanedimethanol residues;
(iii) 0 to less than 15 mole % total diethylene glycol residues, whether or not formed in situ;
wherein the total mole % of the dicarboxylic acid component is 100 mole %, and wherein the total mole % of the glycol component is 100 mole %.

8.-14. (canceled)

15. A voided film comprising:
(1) 70-99 wt % of a polymer composition comprising at least one polymer selected from acrylic polymers, polyolefins, cellulose esters, cellulose acetate, cellulose triacetate, cellulose propionate, cellulose butyrate, cellulose acetate propionate, cellulose acetate butyrate, cellulose propionate butyrate, cyclic olefin copolymers, ethylene methyl acrylate copolymer, polycarbonate, polypropylene, polystyrene, polystyrene butadiene copolymers or blends, polyethylene, ethylene/propylene copolymer, ethylene-vinyl acetate (EVA), ethylene vinyl alcohol copolymer, polyvinyl chloride, poly(lactic acid), polyvinylidene chloride, nylon, polyethylene terephthalate (PET), polyesters, copolyesters, and mixtures thereof; and
(2) 1-30 wt % of hollow glass microspheres, wherein the at least one polymer comprises a polyester composition comprising:
(1) 20-98 wt % of at least one polyester which comprises
(a) a dicarboxylic acid component comprising:
(i) 70 to 100 mole % of terephthalic acid residues
(ii) 0 to 30 mole % of aromatic and/or aliphatic dicarboxylic acid residues having up to 20 carbon atoms; and
(b) a glycol component comprising:
(i) 22 to 83 mole % ethylene glycol residues;
(ii) 15 to 28 mole % 1,4-cyclohexanedimethanol (CHDM) residues;
(iii) 2 to 20 mole percent diethylene glycol (DEG) residues, whether or not formed in situ;
(iv) 0 to 30 mole % of the residues of at least one other modifying glycol; and
wherein the total mole % of the dicarboxylic acid component is 100 mole %, and wherein the total mole % of the glycol component is 100 mole %;
(2) 1-20 wt % of at least one polymer selected from polyolefins, polypropylene, polystyrene, polyethylene, ethylene/propylene copolymer, ethylene vinyl acetate copolymer (EVA), ethylene vinyl alcohol copolymer, polyvinyl chloride, poly(lactic acid), polyesters, copolyesters, and mixtures thereof;
(3) 0-5 wt % ethylene methyl acrylate copolymer; and
(4) 0-5 wt % TiO2.

16.-17. (canceled)

18. The film of claim 15, wherein the film is a shrinkable film that is oriented in at least one direction and has shrinkage from 20 to 90% after 10 seconds in water bath at 95° C. in at least one direction and has a density of 1.6 g/cc or less.

19. The film of claim 15, wherein the film is an extruded film with a density of 1.6 g/cc or less.

20. The film of claim 15, wherein the hollow glass microspheres have a crush strength of at least 250 psi or greater, or have a particle size of 5 to 180 um, or a density of 0.15 to 0.83 g/cc.

21. The film of claim 15, wherein the hollow glass microspheres have a crush strength of at least 10,000 psi or greater and have a particle size of 10 to 50 um and a density of 0.30 to 0.60 g/cc.

22. The film of claim 15, wherein the film is a shrinkable film that is oriented in at least one direction and has shrinkage from 20 to 90% after 10 seconds in water bath at 95° C. in at least one direction and has a density of 1.0 g/cc or less and has light transmittance of less than 30% measured in accordance with ASTM D1003 or has a light transmittance of less than 25% measured in accordance with ASTM E1348-02.

23. The film of claim 15, wherein the film is a shrinkable film that has MD growth from 0 to 20% or MD shrinkage from 0 to 20%.

24. The film of claim 15, wherein said film is stretched in one or more directions.

25. The film of claim 15, wherein the film is oriented in one or more directions.

26. The film of claim 15, wherein the film is annealed at a temperature of about Tg to Tg+40° C.

27. The film of claim 15, wherein the film is oriented in one direction, and oriented a second time in one or more directions.

28. A process for making the film of claim 15 which comprises: (i) mixing hollow glass microspheres with the polymer composition of any one of the preceding claims; wherein the hollow glass microspheres are added at a temperature at or above the Tg of said polymer to form a uniform dispersion of said microspheres within said polymer;
(ii) forming a film via extrusion, calendering, casting, drafting, tentering, or blowing; and optionally
(iii) stretching and/or orienting said film of step (ii) in one or more directions; and optionally
(iv) annealing said film from step (iii) at a temperature of about Tg to Tg+40° C.

29. (canceled)

30. The process of claim 28, wherein said film has a shrinkage of at least 60% after 10 seconds in water bath at 95° C. and a density of 0.96 g/cc or less; or at least 40% after 10 seconds in water bath at 95° C. and a density of 0.96 g/cc or less; or at least 50% after 10 seconds in water bath at 95° C. and a density of 0.96 g/cc or less; or at least 20% after 10 seconds in water bath at 95° C. and a density of 0.96 g/cc or less.

31. (canceled)

32. The process of claim 28, wherein the film has MD growth from 0 to 20% and/or MD shrinkage from 0 to 20%.

33. (canceled)
